(19) United States
(12) Patent Application Publication
(10) Pub. No.: US 2014/0314062 A1
(43) Pub. Date: Oct. 23, 2014

(54) Aquatic-Based Automation Systems

(71) Applicant: Dennis Loebs, Sag Harbor, NY (US)

(72) Inventor: Dennis Loebs, Sag Harbor, NY (US)

(21) Appl. No.: 14/252,579

(22) Filed: Apr. 14, 2014

Related U.S. Application Data
(60) Provisional application No. 61/914,239, filed on Dec. 10, 2013.
(60) Provisional application No. 61/814,086, filed on Apr. 19, 2013.

(51) Int. Cl. H04L 12/28; H04W 84/12

(52) U.S. Cl. CPC H04L 12/2803; H04W 84/12
USPC 370/338

(57) ABSTRACT

Described are hardware, software and related control systems using a mesh network in an environment that incorporates aquatic vessels such as pools, spas and fountains. The system uses fully wireless and semi-wireless devices in conjunction with various components within the aquatic system. Integrated hardware-based and software-based solutions are also present for the improved maintenance, monitoring and operation of home-based systems with aquatic vessels.

### REFERENCE TO PRIOR APPLICATIONS

This application is a based on a provisional application, U.S. Ser. No. 61/814,086, filed Apr. 19, 2013 and provisional application, U.S. Ser. No. 61/914,239, filed Dec. 10, 2013.

### FIELD OF THE DISCLOSURE

The present disclosure relates generally to mesh networks for use in an environment that incorporate aquatic vessels such as pools, spas and fountains. More particularly, the present disclosure relates to integrated hardware-based and software-based solutions for the improved monitoring and operation of systems that include such aquatic vessels.

### BACKGROUND

The modern home includes many devices that provide various useful functions to its inhabitants. Such devices include those related to home environment, home entertainment and home functionality. Often some or all of such devices are networked and partially or fully controlled by one or more central controllers. These central controllers may also include functionality that allows partial or total automation of certain devices. The central controller may further be configured within a home network to control the various devices using wired networks, wireless networks, or a combination of the two.

The network may be set up as a mesh network, which is ideally suited to the home environment. Several networks for home automation having wireless devices communicate via mesh networks including INSTEON, Z-Wave, and ZigBee. Generally these home automation devices provide that each wireless device communicates with every other wireless device within range. This increases network reliability because the overall system is able find a path to an intended destination. Further, since signal degradation may be an issue with wireless signals, home automation wireless devices may boost the signal as they pass it the next device. Another advantage to mesh networking in home automation is that if a device in the signal path does not operate properly, the network finds an alternative route to the destination.

Aquatic vessels, including pools, spas and fountains present special challenges within a home network. Because of the environment of these aquatic vessels, special considerations must be taken into account when designing the device that control these vessels. Further, aquatic environments often include numerous accessories such as water features, landscape and underwater lighting, water quality control systems, irrigation systems, and security. Such aquatic vessels and their accessories would benefit from being integrated into a home automation network, which may include the use of a wireless mesh network and a wired network. To date, however, there are no solutions that incorporate one or more small software-intensive control units wirelessly connected to a much larger family of fully wireless, semi-wireless and wired sensors and devices. Accordingly, there is a need for a comprehensive and robust integrated hardware-based and software-based solution for the improved monitoring and operation of systems that include such aquatic vessels and their accessories.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a mesh network incorporating wireless and semi-wireless devices in accordance with some embodiments.

FIG. 2 is a schematic diagram of a control system showing operation of a mesh network operated via Internet in accordance with some embodiments.

FIG. 3 is a schematic diagram of a control system showing operation of a mesh network operated via central controller in accordance with some embodiments.

FIGS. 4A and 4B are schematic diagrams of a fully wireless device interface for use in a mesh network in accordance with some embodiments.

FIG. 5 is a schematic diagram of a heater/heat pump/heat exchanger and control node in accordance with some embodiments.

FIG. 6 is a schematic diagram of a variable-speed pool pump and control node in accordance with some embodiments.

FIG. 7 is a schematic diagram of an irrigation valve actuator/solenoid and control node in accordance with some embodiments.

FIGS. 8A and 8B are schematic diagrams of an underwater lighting device and control node in accordance with some embodiments.

FIGS. 9A and 9B are schematic diagrams of a pool valve actuator in accordance with some embodiments.

FIG. 10 is a chart diagram comparing and contrasting the properties of classes of semi-wireless control nodes in accordance with some embodiments.

FIGS. 11A and 11B are schematic diagrams of one or multiple specialized devices that attach to pipes and serve as receptacles for wireless control nodes, in accordance with some embodiments. FIG. 11C is a schematic of these devices with attached wireless control nodes in accordance with some embodiments.

FIGS. 12A and 12B are schematic diagrams of an automatic pool cover used for aquatic vessels in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Described herein is a wireless automation system employing mesh network topology and operating on a low-power RF communications protocol (such as, for example, Z-Wave) that is intended primarily for control of waterscapes, pools, spas, water features, and accessories, as well as landscape lighting, irrigation systems, and outdoor security (e.g., alarms and cameras). The system may also be configured to control non-aquatic-based devices.

The wireless automation system may comprise one or more gateway controllers (known as Air:Hubs herein) and one or more network sensors, switches, controls, or other input or output hardware devices (known as Smart:Nodes herein). Smart:Nodes may include fully wireless nodes (known as Air:Nodes herein) and hybrid, semi-wireless nodes that combine wireless communication and control with a wired power source (known as Bridge:Nodes herein). Bridge:Nodes may be an alternate product choice for indoor installations, retrofit installations, generic control applications, and new installations with special site constraints. The network may also include software that may integrate with devices specially designed to operate in the pool environment. The network described herein may be known by its trade name VERV™ and may be so referred herein.

I. The VERV System Overview

VERV operates via mesh network topology, which allows Smart:Node to Smart:Node communication and Smart:Node to Air:Hub controllers within the wireless automation network. The gateway controller and/or Smart:Nodes may deploy common RF communication protocols to ensure interoperability with most home automation networks and devices, without the need for special adapters or other hardware.

A. An Exemplary Mesh Network: The Z-Wave Protocol

The Z-Wave protocol is an exemplary mesh network protocol that may be used in a VERV system. Use of the Z-Wave certification process ensures interoperability with any other certified Z-Wave node, making this a useful choice when designing mesh networks for home and pool automation.

Z-Wave home automation technology comprises three layers: the radio layer, network layer and application layer. The layers work together to create a robust and reliable network that enables numerous nodes and devices to communicate with each other nearly simultaneously.

The Z-Wave Protocol Radio Layer defines the way a signal is exchanged between network and the physical radio hardware. This includes frequency, encoding, hardware access, etc.

The Z-Wave Protocol Network Layer defines how control data is exchanged between two devices or nodes. This includes addressing, network organization, routing, etc. This layer controls how data is exchanged between different devices (nodes) on the network and consists of three sub-layers.

1. Media Access Layer (MAC): Controls the basic usage of the wireless hardware.

2. Transport Layer: Controls message transfer, ensuring error-free communication between two wireless nodes. The end user cannot influence this layer's functions but the results of this layer are visible.

3. Routing Layer: Manages Z-Wave's “Mesh” capabilities to maximize network range and ensure messages get to their destination node. This layer will use additional nodes to re-send the message if the destination is outside of the “direct” range of the transmitting node.

The Z-Wave Protocol Application Layer defines which messages need to be handled by specific applications in order to accomplish particular tasks such as switching a light or changing the temperature of a heating device.

Each node in the Z-Wave network has a unique identification to distinguish it from other nodes in the same network. The Home ID is the common identification of all nodes belonging to one logical Z-Wave network. It has a length of 4 bytes=32 bits. The Node ID is the address of a single node in the specific network. The Node ID has a length of 1 byte=8 bits. On a single network (one Home ID) two nodes cannot have identical Node IDs.

Z-Wave networks include two basic types of devices: Controllers (devices that control other Z-Wave devices) and slaves (devices that are controlled by other Z-Wave devices). Controllers are generally factory-programmed with a Home ID, that cannot be changed by the user. Slaves generally do not have a pre-programmed Home ID as they take the Home ID assigned to them by the network.

In the Z-Wave network setup, the primary controller incorporates other nodes into the network by assigning them its own Home ID. If a node accepts the Home ID of the primary controller this node becomes part of the network. The primary controller also assigns an individual Node ID to each new device that is added to the network. Proper receipt of messages through the network is ensured because every command sent is acknowledged by the receiver which sends a return receipt to the sender.

In a typical wireless network the central controller has a direct wireless connection to all of the other network nodes. This requires a direct radio link from all nodes to all other nodes. In contrast, in a mesh network such as Z-Wave nodes can forward and repeat messages to other nodes that are not in direct range of the controller. Communication can be made to all nodes within the network even if they are outside of direct range or if the direct connection is interrupted. This occurs because each Z-Wave node is able to determine which Z-Wave nodes are in its direct wireless range (called neighbors) and inform the Z-Wave controller about its neighbors.

Using this information, the Z-Wave controller is able to build a table that has all information about possible communication routes in a network. A Z-Wave controller will attempt first to transmit its message directly to the destination. If this is not possible the controller will use its routing table to find the next best way to the destination. The controller can select up to three alternative routes and will try to send the message via these routes. Only if all three routes fail (the controller does not receive an acknowledgement from the destination) the controller will report a failure.

Using the Z-Wave protocol, up to 232 Smart:Nodes or “external” Z-wave devices (nodes) may be connected. The bandwidth of Z-wave is 9.6 or 40 or 100 kbit/s, with speeds fully interoperable. Modulation for Z-Wave is GFSK Manchester channel encoding. The range for Z-Wave network devices is approximately 100 feet (30 m) assuming “open air” conditions, with reduced range indoors depending on building materials. The Z-Wave radio uses the 868.42 MHz SRD Band (Europe); the 900 MHz ISM band: 908.42 MHz (United States); 916 MHz (Israel); 919.82 MHz (Hong Kong); and 921.42 MHz (Australian/New Zealand). In Europe, the 868 MHz band has a 1% duty cycle limitation, thus a Z-Wave unit is only allowed to transmit 1% of the time. Z-Wave units can operate in power-save mode and only be active 0.1% of the time, thus reducing power consumption substantially.

The Z-Wave protocol is only illustrative of one possible embodiment of the VERV system. Other current and future wireless networks may be used in part or all of the VERV system, including IEEE 802.11, WiMax, 6LoWPAN, Bluetooth, WAN, Zigbee, EnOcean, INSTEON, MyriaNed, One-Net, X-10 or other open or proprietary wireless protocols.

B. General Operation of VERV

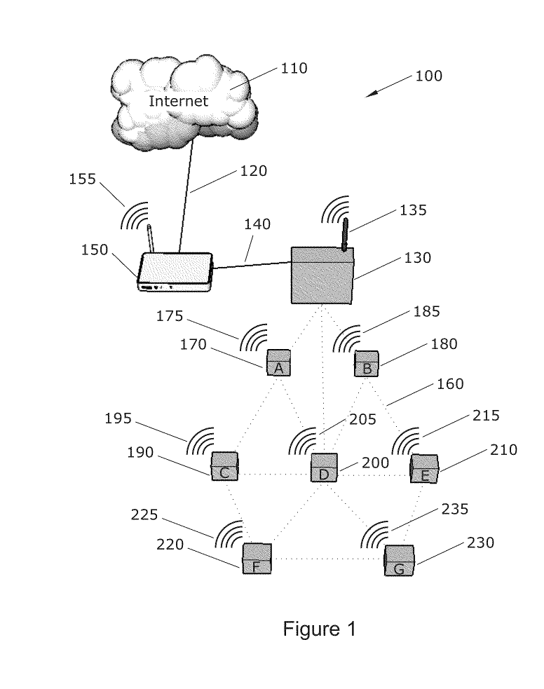

Turning to FIG. 1, shown is a block diagram of a VERV mesh network 100 incorporating Air:Hubs and Smart:Nodes. The internet 110 and internet backbone 120 provide a connection to an outside network via a router 150 that has wireless capability 155. The Air:Hub 130 is connected to the router 150 either wirelessly (Wi-Fi, broadband) 135 or wired (Ethernet cable) 140 and communicates to the wireless transceivers A through G 175, 185, 195, 205, 215 225, 235 that are respectively incorporated with devices A through G 170, 180, 190, 200, 210, 220, 230. Devices A through G 170, 180, 190, 200, 210, 220, 230 may be fully wireless Air:Nodes that operate on battery or solar power or semi-wireless Bridge:Nodes that operate either on battery or solar power or line power. (Specific embodiments of such Smart:Nodes are discussed below.)

VERV operates using distributed intelligence, which leverages mesh topology 160 with on-board control logic to allow each Smart:Node to act as a microcontroller. The mesh topology 160 allows multiple paths of wireless communication between the Air:Hub and the transceivers that are incorporated in Smart:Nodes. As an example, should Air:Hub 130 desire to communicate with device F 220, the Air:Hub 130 can communicate wirelessly 135 to device A 170 through wireless transceiver A 175, then communicate wirelessly to device C 190 through wireless transceiver C 195 and then communicate wirelessly to device F 220 through wireless transceiver F 225. If transceiver C 190 or wireless transceiver 195 becomes inoperable, the Air:Hub 130 can instead communicate wirelessly 135 to device A 170 through wireless transceiver A 175, then communicate wirelessly to device D 200 through wireless transceiver D 205 and then communicate wirelessly to device F 220 through wireless transceiver F 225.

Based on default or user-selectable settings the Smart:Node may perform discrete functions independently of the Air:Hub. This distributed intelligence provides additional layer of safety against unsafe conditions and potential equipment damage.

VERV Smart:Nodes also have the following features:

1. The Smart:Nodes report a device state whenever “wakened” by the user, according to user-managed default settings, by specific command, or based on a user-managed data logging schedule.

2. The Smart:Nodes may incorporate data logging features. These are fully customizable by user and may include graphical data displays with graphs, bar and pie charts. Historical data for users, vessels and devices (e.g. multiple pumps) may be displayed on screen or exported as MS Excel files (*.xls, *.xlsx) or comma-delimited files (*.csv). Data logging schedules may also override user-programmed device settings if the node requires device operation to generate an accurate reading. For example, an inactive pump may be activated briefly to collect water temperature data from pipeline.

Air:Nodes may include on-board energy management features that may display battery charge state on a home/dashboard screen on a user's mobile device (or on the VERV web control portal). The user may also receive text or email alerts when battery charge state is critical. Air:Nodes may be solar powered with 3V, 500 mAh (CR3032) lithium ion (or 3.6V, 2.4 Ah (AA) lithium-thionyl chloride battery backup. The battery may function as primary power source in indoor or in-appliance cabinet installations.

Smart:Nodes may also employ proprietary radio signal shielding technology (known herein as Air:Shield) to minimize signal attenuation and distortion created by nearby metal objects (e.g. pump motors) in their operating environment.

The VERV system may also include an open API that allows home automation manufacturers and integrators to connect easily and inexpensively to the system, with no loss of control capabilities. It also includes modular system architecture that ensures network and device communication compatibility with future RF communication protocols.

Components in the VERV system are designed for maximum energy efficiency and may be RoHS compliant.

II. Hardware Components

A. Hub Controller

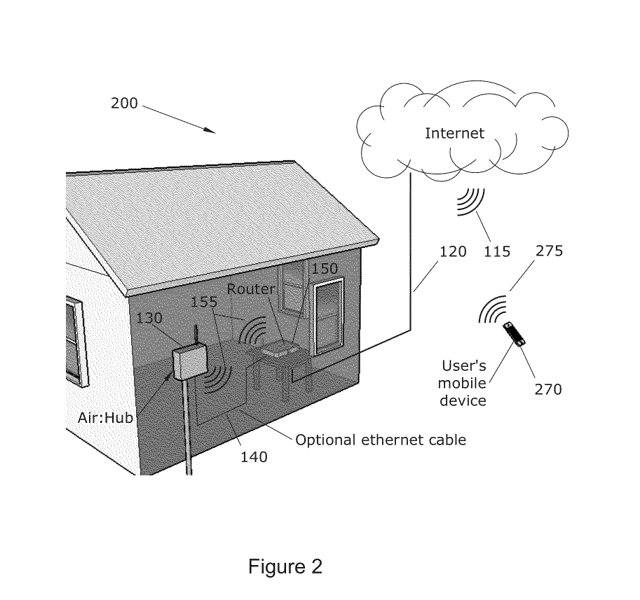

Turing to FIG. 2, shown is a block diagram of a control system 200 for the VERV network having an internet 110 and internet backbone 120 (or wireless internet backbone 115) that provide a connection to an outside network via a router 150 that has wireless capability 155. The Air:Hub 130 is connected to the router 150 either wirelessly (Wi-Fi, broadband) 135 or wired (Ethernet cable) 140.

A user's mobile device 270 may communicate wirelessly 275 to the wireless internet backbone 115 to provide the necessary control functionality for the VERV system. The mobile device 270 may operate an app or other software to perform control functions using remote or distant control via the internet 110.

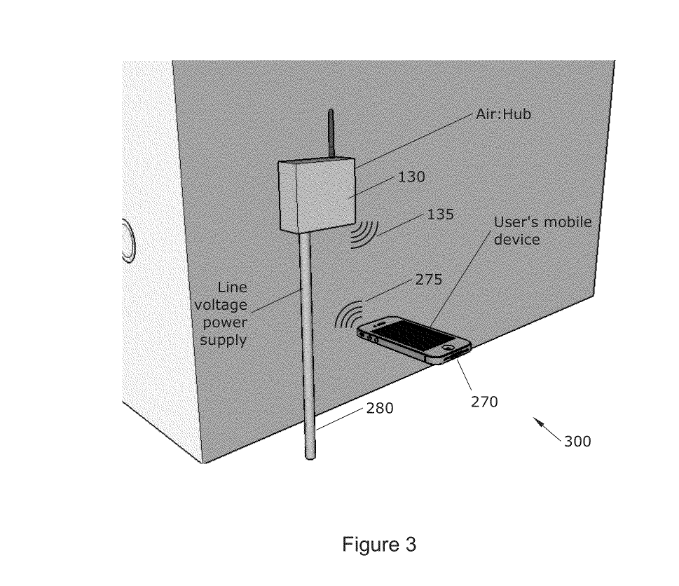

Turing to FIG. 3, shown is a control system 300 for the VERV network having an Air:Hub 130 that is connected wirelessly (Wi-Fi, Bluetooth or broadband) 135 to the rest of the mesh network (not shown). The Air:Hub 130 is powered by a line voltage power supply 280. A user's mobile device 270 may communicate wirelessly 275 to the Air:Hub's wireless transceiver to provide the necessary control functionality for the VERV system. The mobile device 270 may operate an app or other software to perform control functions for the VERV system.

The Air:Hub 130 deploys common RF communication protocols to ensure interoperability with most home automation networks and devices, without the need for special adapters or other hardware. The Air:Hub 130 may include a weatherized enclosure that may incorporate one or more of the following features: compact, wall-mounted, indoor/outdoor NEMA 4/IP65 rating; 120V AC power supply, power cable and plug; integrated line voltage and low voltage surge suppression; weatherized USB connector for connection to mobile devices and the like; weatherized RJ-45 connectors for LAN and home automation network connectivity; membrane or other type of push buttons for device pairing; LED status lights or LCD status panel; and tool-less service access.

The Air:Hub 130 may be operated through a number of control modes, that may incorporate one or more of the following: fully wireless communications in-network Air:Nodes and devices communicate via Z-Wave protocol; other low-power Air:Node level protocol options (e.g. EnOcean, 6LoWPAN); Wi-Fi node level connectivity for Bridge:Nodes; network-level connectivity via Wi-Fi, Z-Wave, Zigbee, Bluetooth (e.g. for local mobile devices), Insteon, or broadband (for local and remote mobile devices); and connectivity to future Smart Grid meters by bridging to Advanced Metering Infrastructures (AMIs) that utilize the ZigBee Smart Energy (SE) Profile.

The Air:Hub 130 may also incorporated support for wired communications, including network-level connectivity to internet and “external” home automation networks via a RJ45 port or equivalent; and connectivity to mobile devices via USB port.

Firmware for the Air:Hub 130 may be updated over the web (with “push” option), via broadband, Bluetooth (from a mobile device), or via micro USB port.

The Air:Hub 130 may include additional features such as an integrated air temperature sensor; integrated humidity sensor; real Time Clock with internet-based calibration; and a GPS module to provide vessel location to GreenMax (described below) database for automatic utility identification.

B. Fully Wireless Nodes

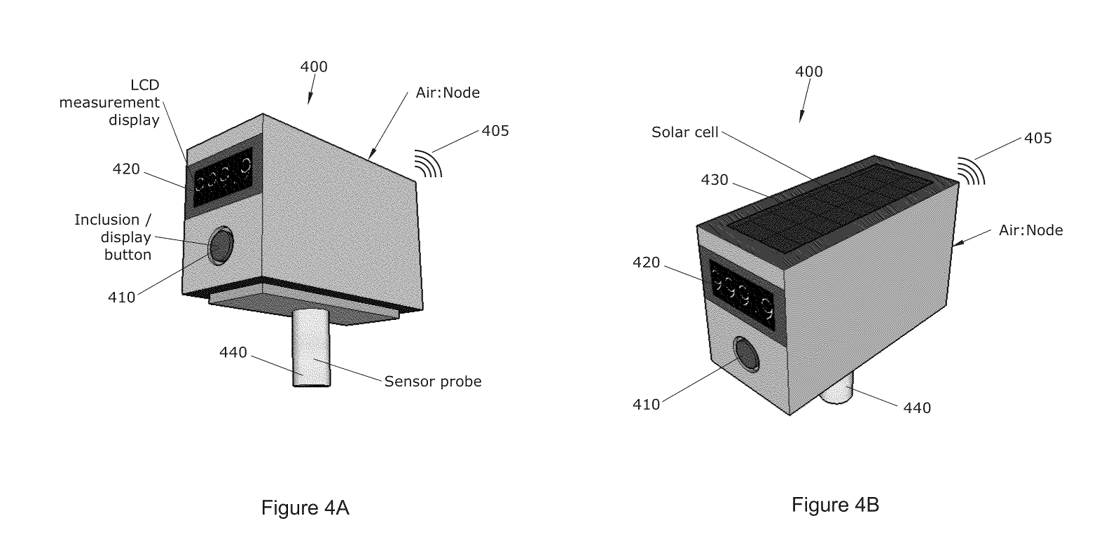

Turning to FIGS. 4A and 4B, shown is a front view and top view of a generic Air:Node 400. Air:Nodes are a class of fully wireless Smart:Nodes that may be installed within the home or pool system to control and monitor the operation of various installed vessels, equipment, and devices. The Air:Node 400 includes wireless capability 405 so that it can communicate with other components within the VERV network. In addition, firmware for the Air:Node 400 may be updated over the web and the mesh network (with “push” option), via Bluetooth (from a mobile device), or via micro USB port.

The Air:Node 400 includes a solar cell 430 for power. As fully wireless devices, Air:Nodes 400 are generally battery-powered and/or solar-powered.

The functions of Air:Nodes 400 vary depending on the nature of the task or function the specific Air:Node 400 performs. For example, many Air:Nodes 400 are pipe-mounted on a modular pipe base (see Air:Base below). As such, the Air:Node 400 may include an LCD measurement/status display 420 and a network inclusion button 410. Pipe-mounted versions of Air:Nodes 400 (see Air:Base below) typically include a sensor probe 440 to monitor and measure physical characteristics of the fluid.

Air:Nodes may take on one or more of the following specific examples.

1. Heating Appliance Control Node

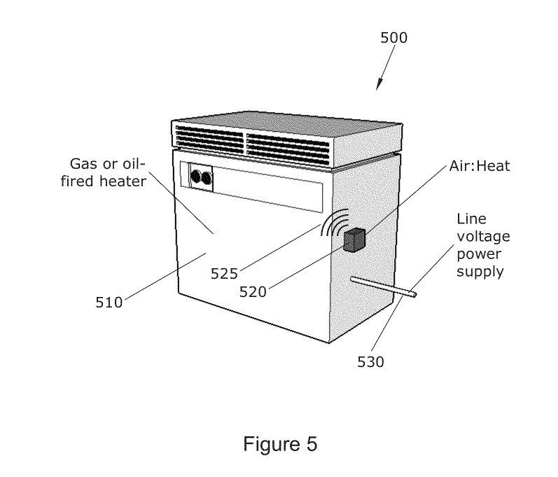

Turing to FIG. 5, shown is an apparatus 500 incorporating a gas or oil-fired heater 510 along with a line voltage power supply 530. (Piping and connections to aquatic filtration system not shown for clarity.) Attached to the heater 510 is Air:Heat 520, a pool/spa heater/heat pump/heat exchanger control node. Air:Heat 520 communicates wirelessly 525 with the remainder of the VERV network and may mount to the exterior of heat appliance cabinets. Air:Heat may include on-board relay which connects to an appliance control circuit and may utilize energy-efficient latching relay coils. Air:Heat may attach to the outside or inside of a heating appliance cabinet at its low-voltage control circuit knockout, using a tool-free method.

Air:Heat generally does not activate a heating appliance unless:

a. The paired pump (default setting filter pump) is activated. If the paired pump turns off unexpectedly, the heat control deactivates after a user-specified interval (“fireman's switch” functionality), even in absence of connectivity to the Air:Hub; and

b. Water flow rate is in manufacturer-specified operating range. (Here, an optional water flow meter Smart:Node called Air:Flow is required; In absence of flow meter Smart:Node, this feature is automatically de-activated.) There is an additional feature where while ordering a system on the VERV web store, the user selects heating equipment information from a drop-down list and the VERV database matches equipment to flow requirement; and

c. Combustion products air flow is in manufacturer-specified range (indoor, vented heater applications only). (Here, an optional air flow meter Air:Node is required. In the absence of air flow meter Air:Node, feature is automatically de-activated.). There is an additional feature where while ordering a system on the VERV web store, the user selects heating equipment information from a drop-down list and the VERV database matches equipment to flow requirement.

Air:Heat may include an integrated air temperature sensor to detect unsafe overheating condition in heater cabinet (including gas heaters installations), which deactivates equipment and sends alert to user. Integrated temperature sensors also control low temperature deactivation point for non-condensing heaters. This safety feature will work even in the absence of connectivity to Air:Hub.

In heat pump applications, Air:Heat may be integrated with the ambient air temperature sensor to control the deactivation point (heat pump only applications) or a switchover point (heat pump+gas heater applications). This energy-saving feature will work even in the absence of connectivity to Air:Hub.

In heat exchanger applications, Air:Heat may include a user option to open/close the supplying zone pump control circuit based on heat call status and flow state of pool pump. In condensation heaters, it may also include an optional surface water sensor (Air:Water) placed in condensate tray to detect and alert users to high condensate level.

Air:Heat may also include installation instructions specific to user's heating equipment.

2. Variable-Speed Pump Controller

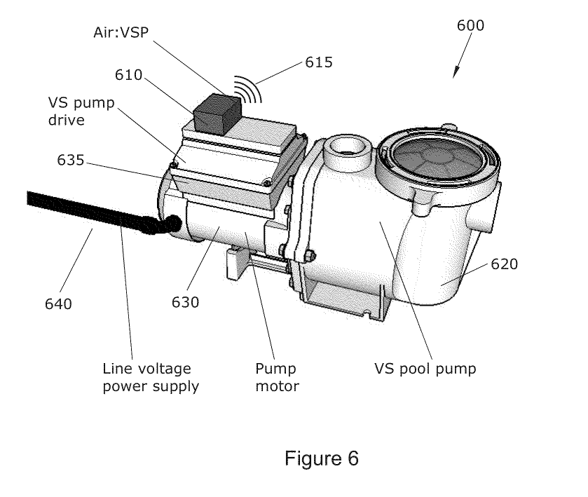

Turning to FIG. 6, shown is an apparatus 600 including a variable speed pool pump 620, a pump motor 630, a variable speed pump drive 635 and a line voltage power supply 640. A variable speed pool pump controller (Air:VSP) 610, installs on the variable-speed drive of common variable-speed pool pumps. Air:VSP 610 communicates wirelessly 615 with the remainder of the VERV network

Users may program (via the Pump:Boss graphical user interface described below) operating schedules and speeds (or accept system defaults) for a connected pump. Users may create their own pump speed-based operating rules (see SmartLogic below) or accept system default features, which may include automatic pump priming mode, automatic filter backwash mode, or GreenMax energy-saving mode (see below). The graphical user control interface may include touch-sensitive dials for pump speed control, with a user-selectable control resolution, as well as display of pump speed in r.p.m. (revolutions per minute) or percentage of maximum. The VERV system may also store pump-specific information in its database, including OEM control parameters and OEM performance data. Default data logging interval for this node may be every fifteen minutes.

3. Water Temperature Sensing Node

The next example of an Air:Node is Air:Temp:H₂O, which is a water temperature sensor node. A standard sensor will be thermistor-based with optional high-accuracy platinum RTD sensors (for therapy spa and other critical control applications). The Air:Temp:H₂O may include default logging intervals (that may be overridden by user) under a schedule such as the following:

A. every hour when paired pump is idle;

B. every thirty minutes when paired pump is operating (heat call is active or inactive);

C. every five minutes when paired pump is spa filter pump, pump is operating, and spa heat call is active.

4. Auxiliary Air Temperature Sensors

The next example of an Air:Node is an auxiliary air temperature sensor (Air:TempAir). A default air temperature sensor may be located in the Air:Hub enclosure with a default logging interval at every hour. Depending upon site-specific conditions, accuracy of some air temperature readings including those at Air:Hub may be adversely affected by location. Therefore, users can select any specific Air:Node to read system default air temp, or an average of readings from multiple user-selectable Air:Nodes.

In addition, the Air:TempAir may include user-selectable low or high temperature control, safety, and alert functions to be configured, for example, as a freeze protection device.

5. Pressure Sensors

Another example of an Air:Node is a fluid (typically water) pressure sensor, which may be pipe-mounted, pump-mounted, or filter-mounted. It displays digital pressure reading in user-selectable units upon actuation of a membrane button on its body or a remote trigger. The pipe-mountable version mates with an Air:Base modular pipe base. A separate version for filter- and pump-mounting may include a ¼″ MPT mount for industry-standard filter analog gauge replacement and ¼″ FPT outlet (pluggable) that allows installation of auxiliary analog gauge. Default logging interval for these sensors may be every hour. Users may program discrete actions or accept system defaults, including safety functions, to occur upon reaching user-selectable or default pressure limits, e.g. turning off a pump when dangerous pressure is detected.

6. Vacuum Sensors

Another example of an Air:Node is a vacuum gauge, which may be pipe-mounted, pump-mounted, or filter-mounted. It displays digital vacuum reading in user-selectable units upon actuation of a membrane button on its body or a remote trigger. The pipe-mountable version mates with an Air:Base modular pipe base. A separate version for filter- and pump-mounting may include a ¼″ MPT mount for industry-standard filter analog gauge replacement and ¼″ FPT outlet (pluggable) that allows installation of auxiliary analog gauge. Default logging interval for these sensors may be every hour. Users may program discrete actions or accept system defaults, including safety functions, to occur upon reaching user-selectable or default vacuum limits, e.g. turning off a pump or sounding a safety alarm when dangerous vacuum in a suction pipeline is detected.

7. Flow Sensors

Another example of an Air:Node is a flow sensor (Air:Flo), which may be a paddle-type self-powered sensor or may operate on solar/battery power, and may mate with Air:Base modular pipe base. It displays digital flow reading in user-selectable units upon actuation of a membrane button on its body or a remote trigger. Default logging for this sensor may be every thirty minutes. Users may program discrete actions or accept system defaults, including safety functions, to occur upon reaching user-selectable or default flow limits, e.g. turning off a pump or increasing the speed of a pump when equipment-specific minimum flow rates are detected. The VERV system may also store such equipment-specific flow rates in its database. For example, if the minimum flow rate for a gas heater fails to be met, then a user-programmed or system default action may be to increase the pump speed causing an increase in flow, to prevent a dangerous overheating condition.

8. Fluid Level Sensors

Another example of an Air:Node is a fluid level sensor (Air:Level). This is intended for water level sensing and control and for chemical tank applications and the like. The fluid sensor may include contact and non-contact versions. The fluid sensor may include dedicated brackets and mountings for 1) Stilling well mount; 2) internal (to pool vessel wall) combination (overflow/level sensing) fitting; 3) external (to pool vessel wall) deck-level combination (overflow/level sensing) fitting; 4) mount for standard pool skimmers; 5) tank top mount (for thin and thick wall); 6) tank (inside) side mount (for thin and thick wall); and tank (outside) side mount (non-contact, thin wall).

The fluid level sensor may include various functional types including a conductivity fluid level sensor (Air:Level:C), which provides an inexpensive single-point contact solution and has moderate precision for simple “fill only” pool/spa applications. It may instead be an optical fluid level sensor (Air:Level:O), which also provides inexpensive single-point or multi-point contact solution and good precision for applications with more than one control point. Or it may instead be an ultrasonic fluid sensor (Air:Level:U), which is multi-point, precision non-contact solution, primarily for surge vessel applications. For this sensor type, a user selects via software discrete control actions (start/stop equipment, fill/dump a vessel, create an alert, etc.) at any water level. The ultrasonic sensor has a low-profile form factor, minimal deadband and unlimited user-configurable level set points. Or it may instead be a pressure fluid sensor (Air:Level:P), which is a multi-point contact solution primarily for surge vessel applications. In this sensor type, the user selections via software discrete control actions (start/stop equipment, fill/dump a vessel, create an alert, etc.) at any water level and it includes unlimited user-configurable level set points.

9. Rain Sensor

Another example of Air:Node is a rain sensor (Air:Rain), which may mate with Air:Base. Default logging for this sensor may be every hour. Users may program discrete actions or accept system defaults, to occur upon reaching user-selectable or default rain accumulation or rate limits, e.g. locking out a fill valve for a user-selected or system default time period following a rain accumulation of x inches.

10. Accumulated Water Sensor

Another example of Air:Node is an accumulated water sensor (Air:Puddle). This sensor serves to detect accumulated water in sensitive areas, for example, in overflow pipes, on equipment pads (for indoor installations) or in heater condensate trays. Default logging for this sensor may be every hour. Users may program discrete actions or accept system defaults, to occur upon detection of standing water, e.g. sending a text or email alert to service personnel or shutting off pumps when water is detected on the floor of an equipment area.

11. Wind Speed Sensor

Another example of Air:Node is a wind speed sensor (Air:Wind), which may mate with Air:Base and be semi-self-powered by wind energy or may operate on solar/battery power. It displays digital wind speed reading in user-selectable units upon actuation of a membrane button on its body or a remote trigger. Default logging for this sensor may be every hour. Users may program discrete actions or accept system defaults, to occur upon wind speed reaching user-selectable or system default limits, e.g. shutting off a fountain or water feature pump when wind speed exceeds the limit.

12. Oxidation Reduction Potential Sensor

Another example of Air:Node is an oxidation reduction potential sensor (Air:ORP), which may mate with Air:Base. It displays ORP reading upon actuation of a membrane button on its body or a remote trigger. Default logging for this sensor may be every hour. Users may program discrete actions or accept system defaults, to occur ORP reading falls below or exceeds user-selectable or system default limits, e.g. turning a chemical feed pump on or off (such actions may be integrated into the Water:Boss water quality management system described below), or sending a text or email alert to service personnel.

13. pH Sensor

Another example of Air:Node is a pH sensor (Air:pH), which may mate with Air:Base. It displays digital pH reading upon actuation of a membrane button on its body or a remote trigger. Default logging for this sensor may be every six hours. Users may program discrete actions or accept system defaults, to occur when pH reading falls below or exceeds user-selectable or system default limits, e.g. turning a chemical feed pump on or off (such actions may be integrated into the Water:Boss water quality management system described below), sending a text or email alert to service personnel, or shutting off a pump to prevent equipment damage (e.g. to a copper heat exchanger with low-pH water running through it).

14. Salinity Sensor

Another example of Air:Node is a salinity sensor (Air:Salt), which may mate with Air:Base. It displays digital salinity reading in user-selectable units upon actuation of a membrane button on its body or a remote trigger. Default logging for this sensor may be every 12 hours. Users may program discrete actions or accept system defaults, to occur when salinity reading falls below or exceeds user-selectable or system default limits, e.g. deactivating an electrolytic cell when salinity falls below the set limit, or sending a text or email alert to service personnel.

15. Turbidity Sensor

Another example of Air:Node is a turbidity sensor (Air:Turb), which may mate with Air:Base. It displays digital turbidity reading in user-selectable units upon actuation of a membrane button on its body or a remote trigger. Users may program discrete actions or accept system defaults, to occur when turbidity reading falls below or exceeds user-selectable or system default limits, e.g. deactivating an automatic backwash cycle (or deactivating filter pump in manual systems) after user-selectable interval (default setting may be fifteen seconds) of clear water detected in backwash pipeline, or sending a text or email alert to service personnel. The default logging interval in backwash application may be every second during filter backwash, or never. In other applications, the default logging interval may be every twelve hours.

16. UV Light Sensor

Another example of Air:Node is a UV light sensor (Air:UV), which may mate with Air:Base. It displays digital UV output level reading upon actuation of a membrane button on its body or a remote trigger. Default logging for this sensor may be every twenty-four hours. Users may program discrete actions or accept system defaults, to occur when UV output reading falls below user-selectable or system default limits, e.g. deactivating a UV disinfection lamp or system when output level falls below 40 mJ/cm² (or other user-configurable setting), or sending a text alert to service personnel.

17. Electrical Current Sensor

Another example of Air:Node is an electrical current sensor (Air:Juice). Line-voltage electrical current sensors may be used with GreenMax energy-saving applications, described below and with safety-vacuum release system pump control and other safety functions. This node may be installed on a pump motor (or other appliance) housing, on an electrical supply panel, or on a surface-mounted electrical device or junction box. Default logging interval for these sensors may be every hour.

18. Safety or Alarm Sensors

Other examples of Air:Nodes include safety or alarm sensors such as for smoke/carbon monoxide (Air:CO), ambient ozone (Air:O₃), natural/LPG (propane) gas (mounted at head of propane tank, and/or near heating appliance) (Air:Gas) or humidity (via a hygrometer) (Air:rH).

19. Irrigation Valve Actuator

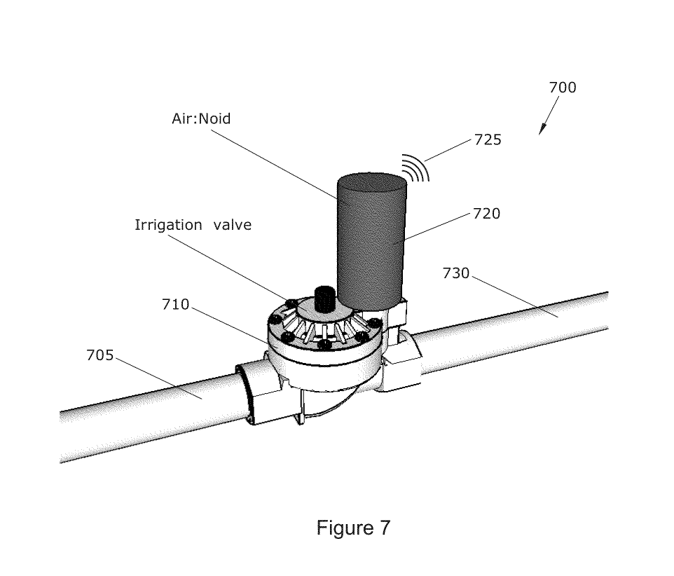

Turning to FIG. 7, shown is apparatus 700 including an inflow pipe 705, an outflow pipe 730 and an irrigation valve 710 situated between them. Also include is an irrigation valve actuator/solenoid control node (Air:Noid) 720, which may be powered by an integral solar/battery (14.8 V/1 Ah lithium polymer) pack. Air:Noid 720 directly fits common valves sold to the irrigation industry. Versions may also feature remote solar cells capable of mounting to a valve box lid or a post. Air:Noid 720 communicates wirelessly 725 with the remainder of the VERV network. The actuator/solenoid in the irrigation valve 710 may include a visual position indicator, manual override and a latching low-power DC relay that minimizes energy consumption and extends solenoid life.

The unique nature of this wireless solenoid actuator apparatus 700 includes its capability to operate in a wireless setting without dedicated or proprietary control hardware.

20. Cover Position Sensor

Another example of Air:Node is an automatic pool cover position sensor (Air:Cover), which may be used to determine the state of a pool cover or the location of its leading edge. This may be powered by a solar/battery (14.8 V/1 Ah lithium polymer) pack. Users may program discrete actions or accept system defaults, to occur based on the cover state, e.g. deactivating a water feature if a closed or partially closed cover interferes with its flow, or automatically opening or closing based on a comparison of water temperature, ambient air temperature, and set point water temperature (for example). Alternately, if another node detects swimming activity in a vessel, the cover could be in a safety lock out mode (in the open state) until the resulting system safety alert is cleared. Users may also program alarms and text or email alerts for cover state for security and/or safety purposes. The graphical user control interface may include touch-sensitive slides for cover position control, with a user-selectable control resolution, as well as a graphical display of cover position or percentage of maximum open/closed.

21. Spa Remote Control Device

Another example of an Air:Node is a “spa-side” remote control device, which may be used to monitor and control various functions in the aquatic system, and serve as an auxiliary control point. It is powered by a solar/battery (14.8 V/1 Ah lithium polymer) pack, has a touch-screen interface and waterproof to 6 feet of depth. It may be waterproof and be handheld or stored in an under-deck docking station.

22. Child Safety Nodes

Another example of Air:Nodes are child-safety nodes, which perform the function of creating an electronic barrier around the pool to prevent unwanted entry into the pool and/or pool area. Embodiments may include: 1) a collection of Air:Nodes that use passive infrared (PIR) sensors to create a barrier or geofence; 2) a collection of Air:Nodes that use a photodetector array to create a barrier or geofence; 3) a collection of Air:Nodes that includes a pool-side water displacement sensor and alarm; and 4) a collection of Air:Nodes that use passive infrared (PIR) sensor to provide individual point-location or range detection. Several of these detection node types may be combined to create multiple layers of protection against unwanted entry. The graphical user control interface may include a graphical map of the node array, indicating status of each therein.

23. Underwater Light Fixture

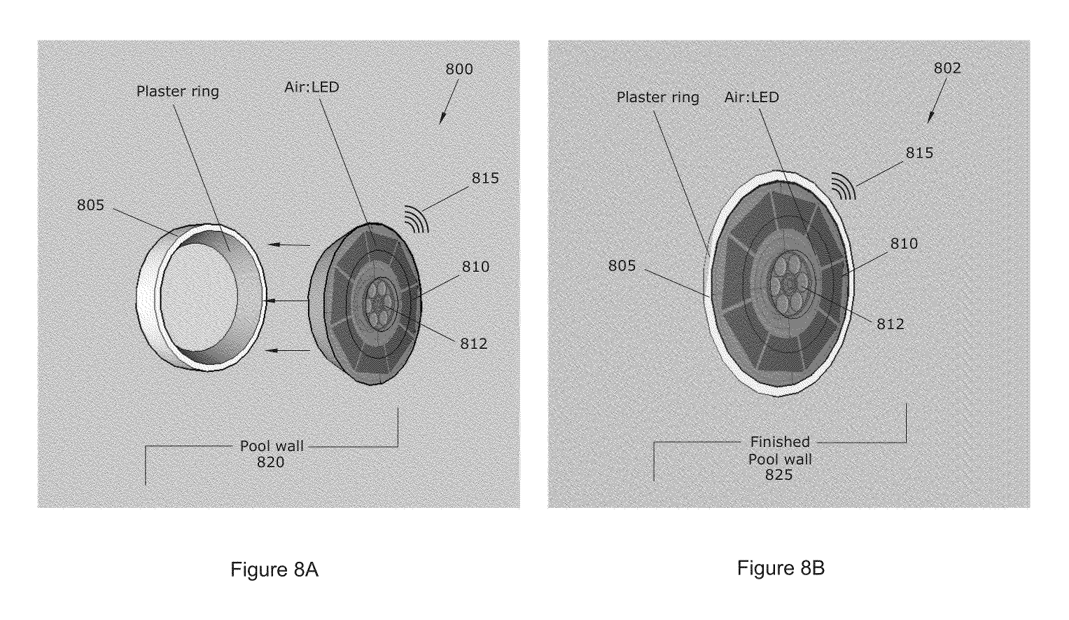

Turing to FIG. 8A shown is a fixture 800 with an underwater light 812 in the process of being installed via a plaster ring 805 into the pool wall 820. Turing to FIG. 8B shown is a fixture 802 with an underwater light 812 installed into finished the pool wall 825 via the plaster ring 805. The fixture includes a control node Air:LED 810, which monitors and controls the underwater light 812 and communicates wirelessly 815 with the VERV network. The fixture may have niche-less design and a low aesthetic and/or physical profile. It may be powered by a battery or solar power and the luminaire may be LED or other light-generating device. The underwater fixture may include waterproofing features and be configured to alert the VERV system when the light malfunctions.

24. Total Alkalinity Sensor

Another example of Air:Node is a total alkalinity sensor (Air:TA), which may mate with Air:Base. It displays TA reading upon actuation of a membrane button on its body or a remote trigger. Default logging for this sensor may be every six hours. Users may program discrete actions or accept system defaults, to occur when TA reading falls below or exceeds user-selectable or system default limits, e.g. turning a chemical feed pump on or off (such actions may be integrated into the Water:Boss water quality management system described below), or sending a text or email alert to service personnel.

25. Total Dissolved Solids Sensor

Another example of Air:Node is a total dissolved solids (Air:TDS), which may mate with Air:Base. It displays digital TDS reading upon actuation of a membrane button on its body or a remote trigger. Default logging for this sensor may be every twenty-four hours. Users may program discrete actions or accept system defaults, to occur when total dissolved solids reading falls below or exceeds user-selectable or system default limits, e.g. turning a chemical feed pump on or off (such actions may be integrated into the Water:Boss water quality management system described below), or sending a text or email alert to service personnel.

26. Calcium Hardness Sensor

Another example of Air:Node is a total dissolved solids (Air:HardCal), which may mate with Air:Base. It displays digital calcium hardness reading upon actuation of a membrane button on its body or a remote trigger. Default logging for this sensor may be every twenty-four hours. Users may program discrete actions or accept system defaults, to occur when calcium hardness reading falls below or exceeds user-selectable or system default limits, e.g. turning a chemical feed pump on or off (such actions may be integrated into the Water:Boss water quality management system described below), or sending a text or email alert to service personnel.

27. Total Hardness Sensor

Another example of Air:Node is a total dissolved solids (Air:HardTotal), which may mate with Air:Base. It displays digital total hardness reading upon actuation of a membrane button on its body or a remote trigger. Default logging for this sensor may be every twenty-four hours. Users may program discrete actions or accept system defaults, to occur when total hardness reading falls below or exceeds user-selectable or system default limits, e.g. turning a chemical feed pump on or off (such actions may be integrated into the Water:Boss water quality management system described below), or sending a text or email alert to service personnel.

28. Phosphate Sensor

Another example of Air:Node is a total dissolved solids (Air:Phos), which may mate with Air:Base. It displays digital phosphate reading upon actuation of a membrane button on its body or a remote trigger. Default logging for this sensor may be every twenty-four hours. Users may program discrete actions or accept system defaults, to occur when phosphate reading falls below or exceeds user-selectable or system default limits, e.g. turning a chemical feed pump on or off (such actions may be integrated into the Water:Boss water quality management system described below), or sending a text or email alert to service personnel.

29. Carbon Monoxide Sensor

Another example of Air:Node is a carbon monoxide sensor (Air:CO), which may mate with Air:Base, have a wall mount, or an appliance mount. Users may program discrete actions or accept system defaults, to occur when CO reading exceeds system limits, e.g. deactivating a gas-fired heater, sounding an safety alarm, or sending a text or email alert to service personnel.

30. Ambient Ozone Sensor

Another example of Air:Node is an ambient ozone sensor (Air:O₃), which may mate with Air:Base, have a wall mount, or an appliance mount. Users may program discrete actions or accept system defaults, to occur when O₃ reading exceeds system limits, e.g. deactivating an ozone generator, sounding an safety alarm, or sending a text or email alert to service personnel.

31. Fuel Gas Sensor

Another example of Air:Node is a fuel gas (natural gas or LPG) sensor (Air:Gas), which may mate with Air:Base, have a wall mount, or an appliance mount. An LPG version may also be mounted at the head of a fuel tank. Users may program discrete actions or accept system defaults, to occur when ambient gas reading exceeds system limits, e.g. deactivating a gas-fired heater, sounding an safety alarm, or sending a text or email alert to service personnel.

32. Humidity Sensor

Another example of Air:Node is a relative humidity sensor (Air:rH), which may mate with Air:Base, have a wall mount, or an appliance mount. Users may program discrete actions or accept system defaults, to occur when rH reading exceeds user-selectable or system limits, e.g. deactivating an ozone generator, activating a chemical feed pump (such actions may be integrated into the Water:Boss water quality management system described below), activate an air conditioning (HVAC) system (indoor installations), or sending a text or email alert to service personnel.

33. ChoreoSwitch Actuator

Another example of Air:Node is a valve actuator/solenoid (Air:Choreo) designed to wirelessly control a ChoreoSwitch manufactured by Crystal. This may be powered by a solar/battery (14.8 V/1 Ah lithium polymer pack) and may include a latching low-power DC relay that minimizes energy consumption and extends solenoid life. This node is designed for continuous submersion while directly mounted to a ChoreoSwitch for its intended application in architectural or decorative fountains. The features of this valve actuator may include an external radio antenna that pierces the water plane.

34. Butterfly Valve Actuator

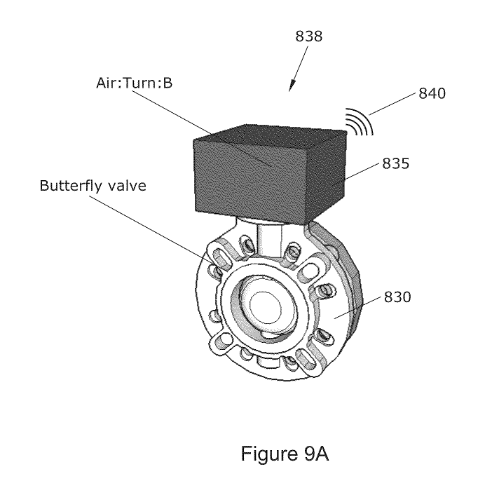

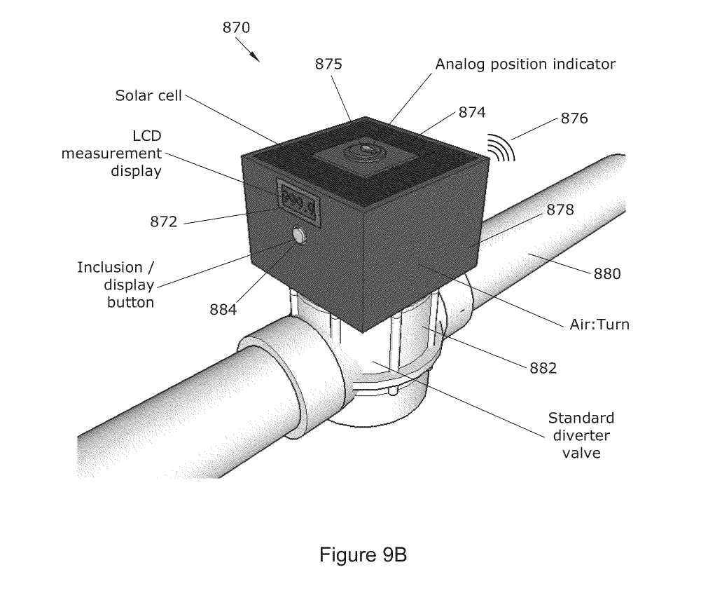

Turning to FIG. 9A, shown is a butterfly valve actuator (Air:Turn:B), another example of Air:Node. FIG. 9A shows an apparatus 838 including a butterfly valve 830 which is controlled by control node 835 (Air:Turn:B). Air:Turn:B 720 communicates wirelessly 840 with the remainder of the VERV network, and is designed for direct mounting on standard ISO butterfly valve actuator mounts.

The actuator 835 may be powered by a solar cell and/or a battery and include a DC servo motor or stepper motor and controller w/0.9° resolution. The features of this pool valve actuator 835 may include a visual (analog) position indicator, manual toggle switch, manual (power off) override and a push-to-display button that activates a digital LCD position indicator that confirms actual position in degrees. The actuator 835 may include an optional vibration-powered model that employs a piezoelectric cantilever to power the actuator.

35. Diverter Valve Actuator

Turning to FIG. 9B, shown is a diverter valve actuator (Air:Turn), another example of Air:Node. FIG. 9A shows an apparatus 870 including a standard pool diverter valve 882 which is controlled by control node 878 (Air:Turn), installed in a PVC pipeline 880. Air:Turn 878 communicates wirelessly 876 with the remainder of the VERV network, and is designed for direct mounting on standard pool industry diverter valves.

The actuator 878 may be powered by a solar cell 874 and/or a battery (14.8 V/1 Ah lithium polymer pack) and include a DC servo motor or stepper motor and controller w/0.9° resolution. The features of this pool valve actuator 878 may include a visual (analog) position indicator 875, manual toggle switch, manual (power off) override and a push-to-display button 884 that activates a digital LCD position indicator 872 that confirms actual position in degrees. This pool valve actuator 878 eliminates the need for micro switches and adjustment cams and includes a gearbox designed for maximum efficiency. The actuator 878 may include an optional vibration-powered model that employs a piezoelectric cantilever to power the actuator.

C. Semi-Wireless Nodes

Semi-wireless nodes (or Bridge:Nodes) are those have both wireless and wired connectivity. As such, Bridge:Nodes are either mounted in or on devices that are line-powered, or are fed by directly by available line power, and communicate, monitor, and control end devices wirelessly via the mesh network. Unlike Air:Nodes, most Bridge:Nodes do not allow powering the Node via battery power or solar energy (see Dedicated Bridge:Node exceptions below). Like Air:Nodes, firmware for Bridge:Nodes may be updated over the web and the mesh network (with “push” option), via Bluetooth (from a mobile device), or via micro USB port. All of the Bridge:Nodes described below may feature additional integrated or optional wireless sensing Air:Nodes, e.g. current sensing Nodes (Air:Juice), temperature sensing Nodes (Air:TempAir), relative humidity sensing Nodes (Air:rH).

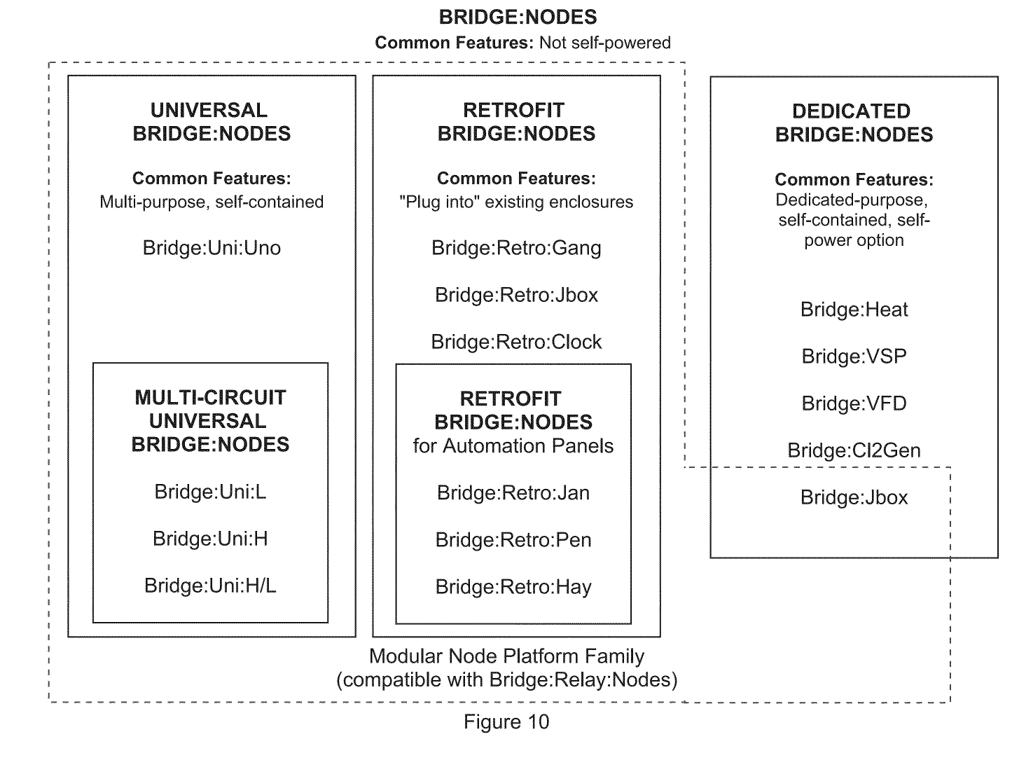

As shown in FIG. 10, Bridge:Nodes are divided into three distinct classes 890:

1. Universal Bridge:Nodes 891;

2. Retrofit Bridge:Nodes 892;

3. Dedicated Bridge:Nodes 893.

The first two classes (Universal Bridge:Nodes 891 and Retrofit Bridge:Nodes 892) are Node platforms that share a family of modular relay nodes (Bridge:Relays). As such, each node in these two classes provides a socketed mounting platform for one or more modular Bridge:Relay:Nodes.

Bridge:Relay:Nodes are pluggable relay modules that snap into corresponding sockets found on compatible Bridge:Nodes. These wirelessly monitored and controlled modular relay nodes maximize system flexibility by allowing compatible Bridge:Node platforms to be field-configured according to size and type of controlled devices, specific site conditions, as well as user needs. Some or all Bridge:Relay:Nodes may feature additional integrated wireless sensing Air:Nodes, e.g. current sensing Nodes (Air:Juice), temperature sensing Nodes (Air:TempAir), relative humidity sensing Nodes (Air:rH). Members of Bridge:Relay:Node family may include several types including: a general-purpose low-voltage AC relay node (Bridge:Relay:24A); a general-purpose low-voltage DC relay node (Bridge:Relay:24D); a general-purpose low-voltage DC latching relay node (Bridge:Relay:24D:Latch); a general purpose line-voltage (120V) relay node (Bridge:Relay:120A); a line-voltage (120V) power relay node rated for 12.5 A (Bridge:Relay:120A:12); a line-voltage (120V) power relay (contactor) node rated for 25 A (Bridge:Relay:120A:25); a line-voltage (240V) power relay node rated for 6.25 A (Bridge:Relay:240A:6); a line-voltage (120V) power relay node rated for 18.75 A (Bridge:Relay:240A:18). In addition, line-voltage (120 and 240 VAC) Bridge:Relay:Nodes may be offered in different types according to the type of load device controlled, e.g. resistive loads or inductive loads. Other types may include more specialized Bridge:Relay:Nodes, such as those designed to control two-speed pumps, and may generally include line- and low-voltage solid-state relays. (The term “relay” is used herein as an omnibus term denoting any electrically-operated switch, and is intended to include all types of relays, including without limitation, solid-state relays, electromechanical relays, safety (e.g. overload, fault) relays, control relays, and power relays (including contactors).) Like Air:Nodes and the Bridge:Nodes with which they mate, firmware for Bridge:Relay:Nodes may be updated over the web and the mesh network (with “push” option), via Bluetooth, or via micro USB port.

The first class of Bridge:Node, the Universal Bridge:Nodes 891, are all self-contained, flexible, multiple-purpose Nodes and Node platforms, the control functions of which are determined by the type of wireless Bridge:Relay:Nodes selected and installed therein. Universal Bridge:Nodes 891 may take on one or more of the following examples.

1. Universal Single-Circuit Control Node Platform

The first example of a Universal Bridge:Node 891 is a general purpose, self-contained relay node platform (Bridge:Uni:Uno) capable of switching one line-voltage or low-voltage load of various types, based on the mating Bridge:Relay selected and installed. Bridge:Uni:Uno nodes may typically mount directly in or on the controlled device or appliance. An application example may include a Bridge:Uni:Uno mounted to the inside or outside of a pool/spa heater/heat pump cabinet for heater (or chiller) control. Or in a heat exchanger application, a Bridge:Uni:Uno may be mounted to a zone pump or a zone pump relay enclosure. In each case, power for the Bridge:Uni:Uno is provided by connecting to the power or control circuit of the mounted device or appliance.

The next examples of Universal Bridge:Nodes 891 are a set of three (3) multi-purpose, flexible, self-contained Bridge:Node platforms (Bridge:Uni:X), each capable of switching up to sixteen (16) device loads of various types, based on mating Bridge:Relays selected and installed, and supplied by up to four (4) individual circuits. All of the following examples of Universal Bridge:Node 891 platforms may share common features including: a total of twenty enclosure knockouts (up to four supply circuits, plus up to sixteen load circuits); EZWire terminal strips for both supply and load conductor wiring (including neutral conductor busbars), eliminate the use of wire nuts, speed installation, and enhance wire management, service, and troubleshooting; compact enclosures with NEMA 4/IP65 ratings; mounting kits for wall mounting and stake/pole mounting.

2. Universal Multi-Circuit Line Voltage Control Node Platform

The first example of a multi-circuit Universal Bridge:Node 891 platform, Bridge:Uni:H, is designed to control line-voltage device loads, with some architectural similarity with a common electrical load panel. Four (4) line voltage supply busbars each may incorporate four (4) relay sockets that mate with pluggable wireless Bridge:Relays:Nodes, for a total of sixteen (16) available relay sockets. Each supply voltage busbar, fed by a single electrical conductor, may be rated for 120 VAC (nominal) and a 25 A (Amp) total load, or a total Node load capacity of 100 A (Amp). In turn, each of the four (4) relay sockets on a busbar may each support a 6.25 A load capacity, totaling the 25 A total load capacity of that busbar. The modular socket architecture of the Bridge:Uni:H may permit the installation of wireless Bridge:Relay:Nodes of varying voltages (120 VAC, 240 VAC nominal) and sizes (6 A . . . 25 A). For example a 240 VAC Bridge:Relay:Node may plug into sockets connected across two supply busbars, with each connected busbar connected in turn to a single conductor in a 240 VAC supply circuit. Or between one and four 120 VAC Bridge:Relay:Nodes rated for 6 A (for example) may plug into individual sockets connected to a single busbar (connected to a single conductor in a 120 VAC supply circuit), thereby providing wireless control of one to four end device loads on a single supply circuit. Or a 120 VAC Bridge:Relay:Node rated for 12.5 A may plug into a single socket connected to a single busbar, and physically block access to an adjacent socket on the same busbar, thereby precluding accidental overloading of the circuit. The EZWire terminal blocks of the Bridge:Uni:H may also incorporate wiring terminals for neutral conductors (120 VAC circuits) that connect to a neutral busbar.

3. Universal Multi-Circuit Low Voltage Control Node Platform

The second example of a multi-circuit Universal Bridge:Node 891 platform, Bridge:Uni:L, is designed to control low-voltage device loads, with some architectural similarity with a common low-voltage multi-tap transformer for landscape lighting. Each Bridge:Uni:L may contain one or more voltage transformers with 120 VAC input/12 VAC output (nominal), which may be of the Toroidal core type. Four (4) low-voltage (12 VAC nominal) supply busbars each may incorporate four (4) relay sockets that mate with pluggable Bridge:Relay:Nodes, for a total of sixteen (16) available relay sockets. Each supply voltage busbar may be rated for 12 VAC (nominal) and a 1200 W (watt) total load, or a total Node load capacity of 4800 W (watt). In turn, each of the four (4) relay sockets on a busbar may each support a 300 W load capacity, totaling the 1200 W total load capacity of that busbar. The modular socket architecture of the Bridge:Uni:H may permit the installation of Bridge:Relay:Nodes of varying voltages (12 VAC, 24 VAC nominal) and sizes (1 W to 300 W). For example a 24 VAC Bridge:Relay:Node may plug into sockets connected across two supply busbars, each connected busbar connected to a single 12V transformer output. Or between one and four 12 VAC (nominal) Bridge:Relay:Nodes rated for 300 W (for example) may plug into individual sockets connected to a single busbar, thereby providing wireless control of one to four end device loads on a single busbar. Or a 12 VAC Bridge:Relay:Node rated for 600 W may plug into a single socket connected to a single busbar, and physically block access to an adjacent socket on the same busbar, thereby precluding accidental overloading of the circuit. For enhance wiring speed and ease, each load-side wiring point of the EZWire terminal blocks in the Bridge:Uni:H may also incorporate three-pin sockets that mate with connector plugs common to the power supply cables found on standard pool industry 24 VAC valve actuators (PVAs).

4. Universal Multi-Circuit Mixed Voltage Control Node Platform

The third example of a multi-circuit Universal Bridge:Node platform, Bridge:Uni:H/L, is designed to control both line-voltage and low-voltage device loads in a single, divided enclosure. Like Bridge:Node:H and Bridge:Node:L, this dual-voltage Node may feature four busbars and a total capacity of sixteen (16) sockets for mating Bridge:Relay:Nodes. Two of the busbars may be located in a low-voltage compartment, and two in a line-voltage compartment, and each compartment may have a capacity of two supply circuits. The architecture and features of each compartment may otherwise be identical to the corresponding Bridge:Node Center: one half of the Bridge:Uni:H/L may be identical to one half of a Bridge:Uni:H, and the other half of the Bridge:Uni:H/L identical to one half of a Bridge:Uni:L. Consequently a Bridge:Uni:H/L node may be used to connect and wirelessly control up to eight (8) line-voltage load devices and up to eight (8) low-voltage load devices. Thus a more economical, single-Node Center/enclosure solution may be provided for users requiring a modest quantity of mixed-voltage device loads.

Due to the flexible architecture of the Bridge:Node Centers, they may be used either for dedicated control purposes, including as lighting controllers, valve controllers, pump controllers, sprinkler controller, or alternately, as controllers of any combination of suitable load devices of mixed types.

Examples of the second class of Bridge:Node, Retrofit Bridge:Nodes 892, are each designed to retrofit into existing enclosures and junction boxes. Like Universal Bridge:Nodes 891 (above), their control functions are determined by the type of wireless Bridge:Relay:Nodes selected and installed in them. Retrofit Bridge:Nodes 892 may take on one or more of the following examples.

5. Retrofit Control Node Platform for Single-Gang Box

The first example of a Retrofit Bridge:Node 892 platform, the Bridge:Retro:Gang, is a general-purpose node platform designed to fit in a new or existing single-gang (1-gang) electrical box, like any electrical device. A single socket to receive a mating Bridge:Relay:Node of appropriate size and type is provided.

6. Retrofit Control Node Platform for Underwater Light Junction Box

The second example of a Retrofit Bridge:Node 892 platform, the Bridge:Retro:Jbox, is a dedicated-purpose node platform designed to retrofit onto the base of existing, common underwater pool light junction boxes. It incorporates a single Bridge:Relay:Node socket to control one or more underwater pool lights connected to a single control circuit. A Bridge:Relay:Node of appropriate size and type is installed based on the installed lighting load.

7. Retrofit Control Node Platform for Electromechanical Time Control Enclosures

The third example of a Retrofit Bridge:Node 892 platform, the Bridge:Retro:Clock, is a general-purpose node platform designed to retrofit into existing, common electromechanical time control enclosures (e.g. Intermatic 2T2xxxGA series). Like the original electromechanical time control, the Bridge:Retro:Clock would snap into place inside the enclosure, and incorporate one or more sockets to mate with Bridge:Relay:Nodes of the appropriate size and type, based on the installed device load. These node platforms would be used most frequently to control swimming pool filter pumps.

8. Retrofit Control Node Platform for Pool Automation Enclosures

The third example of a Retrofit Bridge:Node 892 platform, is a set of three platforms designed to fit inside enclosure panels used in common residential pool automation systems. As such they are general-purpose, mixed-voltage platforms that replace existing control hardware and wiring. Existing system and device-level functionality may be replicated or expanded by the selection and installation of Bridge:Relay:Nodes of the appropriate size and type, based on the installed device load and type. For example, for a typical residential “pool/spa combination” system, Bridge:Relay:Nodes may be installed to control a shared filtration pump or separate filtration pumps, a shared heater or separate heaters, underwater lighting for each vessel, landscape lighting, valve rotations for filtration switchover or water features, a pool cleaner booster pump, etc. Dedicated Bridge:Retro:Node platforms may be provided for each of three common residential pool automation systems manufactured by Zodiac Systems/Jandy, Pentair Pool Systems, and Hayward Pool Products: Bridge:Retro:Jan; Bridge:Retro:Pen; Bridge:Retro:Hay, respectively.

Examples of the third and final class of Bridge:Node, Dedicated Bridge:Nodes 893, are dedicated-purpose, self-contained control nodes. Unlike Universal Bridge:Nodes 891 and Retrofit Bridge:Nodes 892 (above), they do not mate with modular Bridge:Relay:Nodes (see Bridge:Jbox exception below)—they incorporate dedicated-purpose, permanently installed switches. Dedicated Bridge:Nodes 893 may take on one or more of the following examples.

9. Dedicated Control Node for Heating Appliances

The first example of a Dedicated Brige:Node, Bridge:Heat, is in all respects identical to the node Air:Heat (described above), except that it may connect to the power or control circuit voltage of the appliance to which it is mounted, for the purpose of powering its own functions (e.g. wireless radio, control board, relay coil). Alternately, it may be identical without exception to Air:Heat, and if connected to an external power source as described above, automatically detect such connection, and disable its own battery/solar power system.

10. Dedicated Control Node for Variable Speed Pumps

The second example of a Dedicated Brige:Node, Bridge:VSP, is in all respects identical to the node Air:VSP (above above), except that it may connect to the power or control circuit voltage of the variable speed pump to which it is mounted, for the purpose of powering its own functions (e.g. wireless radio, control board, relay coil). Alternately, it may be identical without exception to Air:VSP, and if connected to an external power source as described above, automatically detect such connection, and disable its own battery/solar power system.

11. Dedicated Control Node for Variable Frequency Drives

The third example of a Dedicated Brige:Node, Bridge:VFD, is a node that incorporates a variable frequency drive (VFD) that connects to and powers standard aquatic pumps of various types and functions. Versions may include the common single-phase input/three-phase output (1 PH in/3 PH out) configuration as well as single-phase input/single-phase output (1 PH in/1 PH out) and three-phase input/three phase output (3 PH in/3 PH out) configurations. It may include safety vacuum release (SVR), power conditioning and equipment protection features, and multiple pump control modes including those based on pump speed, power consumption, electrical current, torque, fluid flow or pressure. Users may use one or more of these control modes in custom SmartLogic control schemes in order to program discrete actions, safeguard users or equipment, sound safety alarms, or send text or email alerts. It may also include a compact, wall-mounted, indoor/outdoor enclosure with NEMA 4/IP65 rating.

12. Dedicated Control Node for Chlorine Generators

The fourth example of a Dedicated Brige:Node, Bridge:Cl₂Gen, is a node dedicated to the control and monitoring of common chlorine generators. A self-contained node that mounts on the exterior of a wall-mounted chlorine generator control enclosure, Bridge:Cl₂Gen may connect to, and derive power from, either the power and/or the control circuit of the chlorine generator. Control capability may be achieved by direct connection to the control circuit of the chlorine generator.

13. Dedicated Control Node for Underwater Lighting

The fifth and final example of a Dedicated Bridge:Node 893, Bridge:Jbox, is in all respects identical to the node Bridge:Retro:Jbox above, except that instead of mounting an existing underwater lighting junction box, it is supplied with its own base, for new installations. It may come in several versions based upon number of conduits and/or light fixtures (luminaires) connected to it, for example: a version to connect a single supply circuit to a single luminaire; a version to connect one or two supply circuits to one or two luminaires; or a version to connect one to four supply circuits to one to four luminaires A Bridge:Jbox node may derive its power from the supply circuits that it connects. One noteworthy feature that distinguishes Bridge:Jbox from other Dedicated Bridge:Nodes 893 is that like Bridge:Retro:Jbox, it is a platform that incorporates sockets for mating modular Bridge:Relay:Nodes. This may allow maximum installation flexibility to accommodate a wide range of lighting fixture types and sizes.

D. Using Air:Base to Physically Install Smart:Nodes

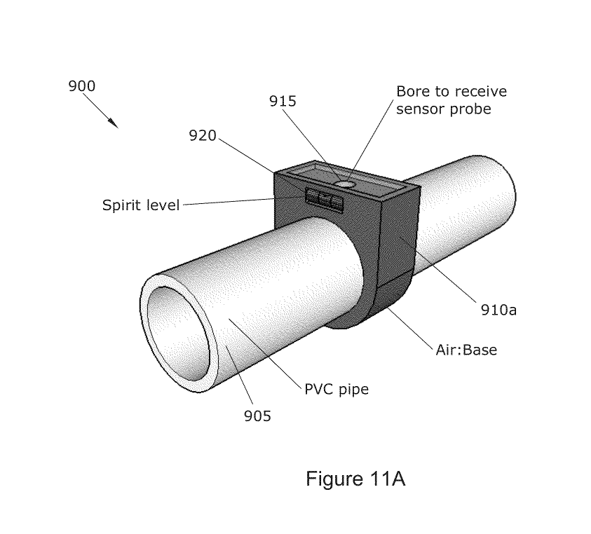

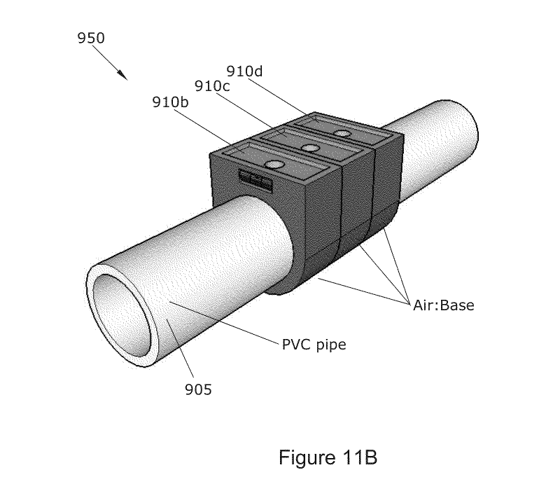

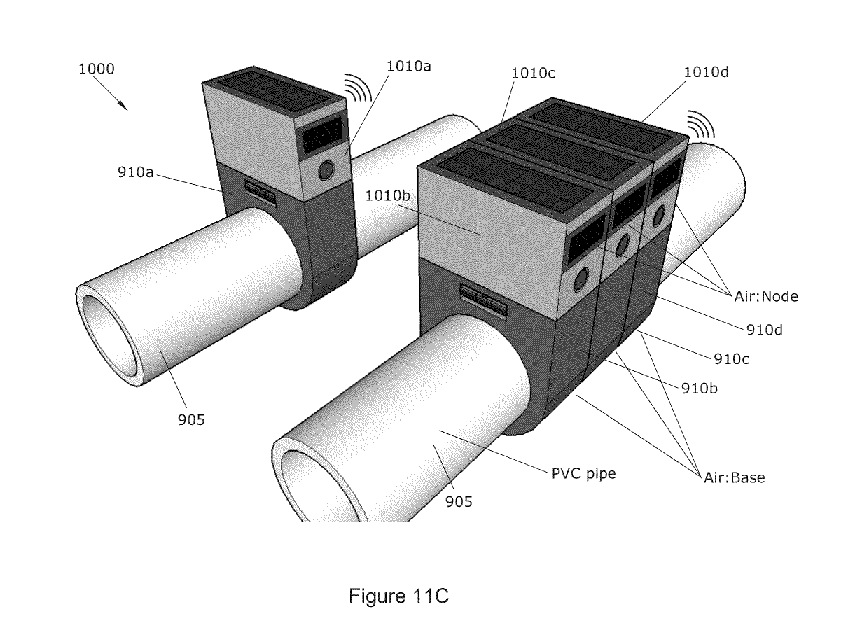

Turning to FIG. 11A, shown is an apparatus 900 of a single Air:Base 910a, which is designed with modular architecture allowing it to mate with all pipe-mounted Air:Nodes in the VERV sensor family. The Air:Base is mounted so as a PVC pipe 905 goes through it. The pipe 905 may be made of any suitable material. The Air:Base 910a includes a spirit level 920 and a bore 915 to receive a sensor probe (the latter an integral part of a mating Air:Node).

Turning to FIG. 11B shown is an apparatus 950 including multiple Air:Bases 910b, 910c, 910d ganged back-to-back, without limit on a single pipe 905.

Turning to FIG. 11C shown are multiple apparatuses 1000 where one Air:Base 910a or multiple Air:Bases 910b, 910c, 910d are installed on pipe 905. Each Air:Base includes a corresponding “modular, mating?” Air:Node 1010a, 1010b, 1010c, 1010d installed on it.

The Air:Base is useful because many aquatic equipment installations require multiple pipeline-based readings (e.g. flow, pressure, temperature, pH) and it provides a fast, universal mounting method for installing multiple, different Air:Nodes to provide such readings.

The Air:Base may include or more of the following features: thermoplastic molded carrier with cam-operated mounting strap; available for all common PVC pipe sizes, including from 1.5″ to 8″; silicone liner ensures maximum grip on pipe while creating water seal; center sensor probe bore and disposable drilling guide ensure perpendicular drilling; molded-in spirit level ensures that carrier is mounted in a horizontally level orientation; Optional flow-powered version includes paddlewheel probe to power attached Air:Node; Optional vibration-powered version employs piezoelectric cantilever to power attached Air:Node; Molded registration tabs ensure that ganged Air:Bases self-align during installation; battery compartment accessible from top or side allows battery replacement without pipeline shutdown; and cam-operated sensor retention clamp that may be adjustable.

Air:Bases may be constructed in standardized fashion to be ensure mating with all wireless nodes in the system. Sensor bodies may snap in place and may be secured by a single cam-operated clamp that may be adjustable. A water seal including a silicone lining, or elastomer O-ring or gasket at the base of sensor probe may be used.

Air:Bases may be used in conjunction with some or all of the foregoing hardware components described herein.

E. Automatic Pool Cover

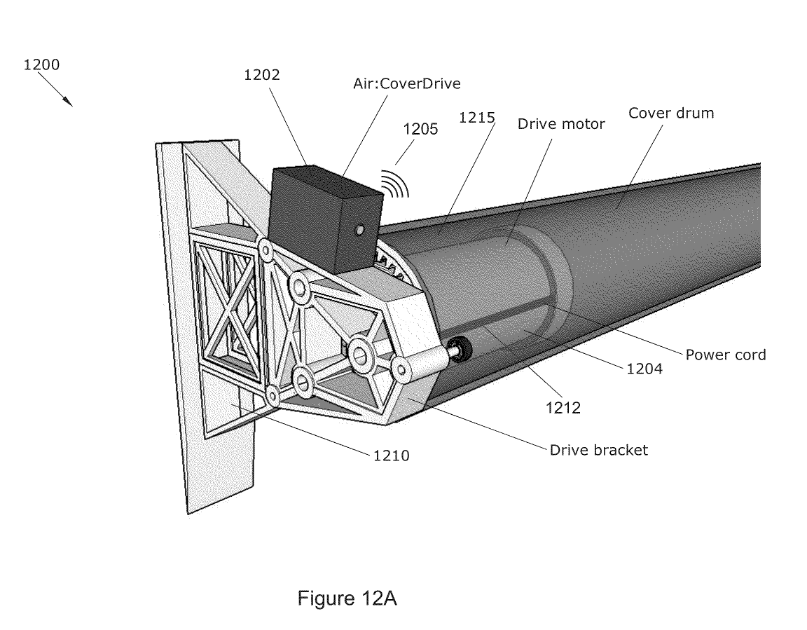

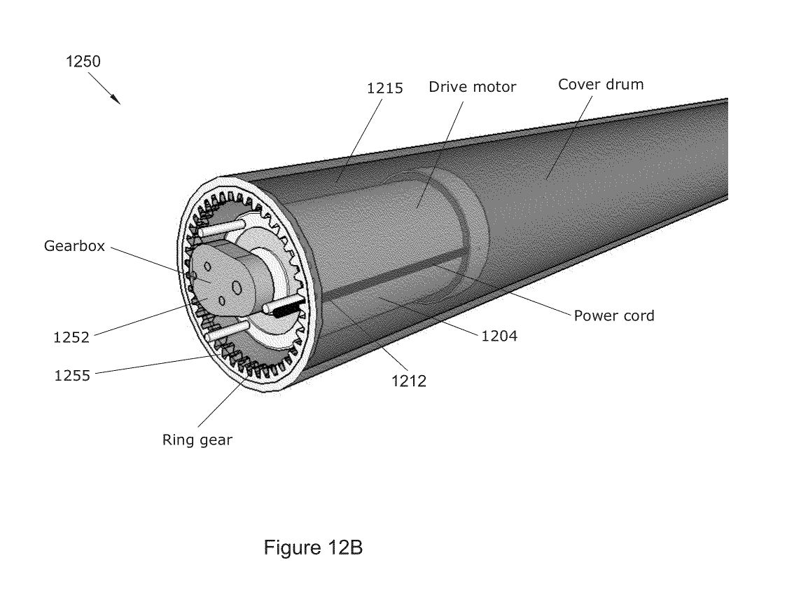

Turing to FIGS. 12A and 12B, shown is an automatic pool cover used for aquatic vessels that is an additional feature of the VERV system. FIG. 12A shows an automatic pool cover drive system 1200 with a drive bracket 1210 and a cover drum 1215. The drive motor 1204 is interposed within the cover drum 1215, connected to the drive bracket 1210 and powered by a power cord 1212. The control node Air:Cover:Drive 1202 monitors and controls the automatic pool cover power and motors and communicates wirelessly 1205 with the remainder of the VERV network. FIG. 12B shows an automatic pool cover drive system with drive bracket removed, revealing a gearbox 1252 and a ring gear 1255 that mechanically drive the pool cover (not shown).

Features of the pool cover may include the use of a Mylar/aramid-reinforced cover (with a transparent option to enhance safety). The cover may include an ultra-compact drive system consisting of separate deployment and retractions drive systems. The cover may be deployed by small electric motors, with elastomer wheels on an enclosed aluminum track, or with pinion gears engaged in a geared aluminum rack/track. Another embodiment may include a magnetic drive linear motor integrated in a modular enclosed track or magnet way. The leading edge of the cover would attach directly to the slider/coil assembly. Alternately, the coil assembly may be incorporated in the stationary track, and the slider may contain the magnets. The cover may feature wireless position and/or motion-sensing components at each end of the leading edge to control retraction and deployment speed and maintain leading edge perpendicularity. The cover may feature a lightweight, low-profile carbon fiber/epoxy composite leading edge. The cover may be retracted via a TEFC electric motor and gearbox mounted concentrically inside a large-diameter cover drum with an end-mounted internal ring gear resulting in an industry-leading minimal-extension cover vault. (“Vault extension” is an industry-specific dimension describing the amount of clearance required for the drive system within an autocover vault, measured from the inside plane of the vessel wall perpendicular to the cover vault, to the inside of the nearest vault wall parallel to the same vessel wall. Standard industry vault extension dimensions are thirty inches (30″) on the side of the vault containing the drive system, and twelve inches (12″) on the non-drive side of the vault,)

Another embodiment of the retraction drive system may include a small-diameter cover drum connected directly to a large-diameter drive wheel with an external ring gear engaged and powered by one or more small electric, hydraulic or other type motors arrayed externally about the circumference of the drive wheel/gear, and oriented with their shafts parallel to the cover drum. A VERV control application may also provide graphic representation and display of the percentage of the open/closed of cover position.

III. Software Features

The VERV system includes multiple software functions to ensure the proper and efficient operation of the hardware components within a unified system.

A. General Features

VERV software includes native control apps for popular mobile device platforms (iOS, Android), Web control application for PC's, support for voice-activated commands for iOS device users via SiriProxy, and Android users via Voice Actions. Email or text alerts about out-of-range conditions can automatically be sent to homeowners or service personnel.

The software uses object-oriented architecture that allows user to control very high number of vessels and Smart:Nodes (up to 232 total per network on Z-Wave) and to control user access to selected components, features, and functionality.

B. User Profiles & Scenes

The VERV system may include pre-loaded, default and template programs, scenes, and program modules for installed Smart:Nodes. Individual users may create personal profiles where control dashboards and other display settings (e.g. measure units, skins) are customized and stored in the Profile. A User may be identified by login or device ID, and VERV automatically displays user's custom dashboards and settings. Profiles can be shared with other network users.

Users may also create multiple Scenes (collections of equipment and Smart:Node states) and store them in their User Profiles. Scenes may activate/deactivate multiple devices with a single touch. Upon activation of a Scene, the VERV system compares the Scene to the currently running programs and prompts user to accept all changes as a group, or retain selected equipment states.

VERV may also learn user behavior and prompt user to accept safety-, energy-efficiency-, or convenience-enhancing changes to their Profile and Scenes.

C. Programming Features

The VERV software may include time programming based on system default or user-created time schedule, with range options for selected months of the year, entire week, weekdays only, weekends only, or specific days of week. Unlimited number of seasonal programs may be entered per calendar year. Seasonal programs may be fully customizable (e.g. start and finish dates, included equipment, parameters). Program run time for any equipment may be automatically modified based on any environmental parameter monitored by a Smart:Node (e.g. ambient temperature, wind, rain, humidity) according to user-selectable parameters. Programs may be temporarily archived for a user-selectable time interval or permanently deleted and include automatic program conflict detection. Change Log records all program and settings changes made by individual users. Calendar views (annual, monthly, weekly, daily) allow users to graphically review programming and highlights conflicts. All system defaults may be overridden by admin-level user. Program templates may be copied and pasted across networks wirelessly via mobile device (Wi-Fi, broadband, Bluetooth), with a PC over the web, or via direct USB connection to the Air:Hub.

Further, Smart:Node:Boss (see below) allows user to configure reminders (via email, text, or in-app) of equipment or Smart:Node state. Upon manual (demand) activation of equipment, Equipment Manager automatically prompts user to set duration of activation (helps to prevent user forgetting to turn equipment off). Interlock:Boss allows user to simply configure all equipment interlocks from a single dashboard screen. And Freeze:Boss allows user to simply configure customizable freeze protection for any equipment.

D. Integration Features

The VERV software system includes full network-level (“upstream”) wireless integration with Home Automation Networks (HANs) operating on Wi-Fi, Z-Wave, ZigBee, X10 and Insteon communication protocols. A VERV API (VAPI) License allows HAN OEMs, dealers and integrators to program custom home-wide functions, fully integrate VERV Smart:Nodes into the HAN, and provide a seamless UX to their customers. VERV Custom Integration Services (VCIS) provides turn-key software integration for HAN OEMs.

The VERV software system also includes semi-automatic node-level (“downstream”) integration with all Z-Wave-Certified nodes and devices manufactured by others, which is possible due to the robust nature of Z-Wave interoperability of certified devices among different manufacturers.

E. Smart Logic

The VERV system also ensures safe and convenient equipment operation without burdening users with unnecessary button presses. For example, a user activation of heater automatically activates and primes a paired pump prior to firing that heater. Further, automatic program conflict detection alerts user to overlapping or conflicting programs, and offers resolution options to “fix” issue automatically by setting rules.

Additional or supplementary rules may be set in the VERV system using a logic builder routine. This allows user to create sophisticated conditional programming using plain language “IF . . . THEN” statements. Thus, any Smart:Node in the network may be used in instruction expressions, e.g. “IF air temp >80° F. THEN turn off heater.” A user may set an unlimited number of “IF” conditions for each statement, e.g. “IF air temp >80° F. and water temp >78° F. and waterfeature is off, THEN turn off heater.” User may also set an unlimited number of “THEN” conditions for each statement, e.g. “IF air temp >80° F., THEN turn off heater and turn off waterfeature and turn on chiller.”

IV. Control Systems

To drive the efficiency of overall VERV system operation, there may be several control systems that integrate hardware and software to operate discrete functions of the VERV system in a user-friendly manner. Each of these may contain a suffix that ends in “:Boss.”

A. Net:Boss

The network-level control as performed by the VERV system may be called Net:Boss. Upon inclusion of a new node into the network, Net:Boss automatically opens on user control interface and automatically recognizes new VERV Smart:Nodes, and opens appropriate Smart:Node:Boss (see below). The user is alerted about default and template program modules available for the new Smart:Node. Additional features may include node exclusion, node power/battery status reporting, and the creation of graphical system map by Net:Boss.

B. Smart:Node:Boss

Installation of new Smart:Node opens Smart:Node:Boss, which presents user with menu choices leading to identification and configuration of equipment connected to the node, by reference to the VERV equipment database, which contains information about all hardware devices that may be added to the VERV system. This database may be dynamically updated as new equipment is introduced into the market.

C. Vessel:Boss

Vessel-level information (pool, spa, fountain) is stored and used by VERV system so that during web purchase process or upon initial VERV system set-up, user is prompted for vessel information including:

a. Number of vessels in network;

b. Type of each vessel (pool, spa, fountain);

c. Name of each vessel; and

d. Dimensional information for each vessel.

e. Structural type of vessel, i.e., vinyl-liner, or concrete with plaster liner, which has implications for water quality management since the optimal range for calcium hardness varies by structure.

This Vessel:Boss information is used by the VERV system to calculate vessel volumes, turnover rates, recommended filtration rates and the like for the entire system. In addition, historical readings for each vessel may be displayed on screen or exported as MS Excel files (*.xls, *.xlsx) or CSV file.

D. Water:Boss

Water:Boss allows users of the VERV system to configure control of popular chlorine generators, chemical feed pumps, CO2 systems, ozone systems, and the like. Water:Boss incorporates graphical data display of readings for each water quality parameter via graphs, bar and pie charts. In addition, historical readings for each parameter may be displayed on screen or exported as MS Excel files (*.xls, *.xlsx) or CSV file. Users may create custom views or dashboards.

Water:Boss may provide an option to automate water quality management based on Langelier Saturation Index (LSI) or based on individual values. For systems using bulk chemicals in tanks (e.g. hypochlorite solution, acid), Water:Boss includes support for low chemical level alerts and tracking chemical consumption, including customizable graphical displays of consumption history. Water:Boss may allow for user-configurable alerts and actions for out-of-range readings.

For manual dosing, Water:Boss calculates correct doses, provides support for manual entry of manual water test results and service screens to collect service and maintenance visit details. Water:Boss may also send email or text report to homeowners reporting regular maintenance routines or developments of interest.

E. Level:Boss

Level:Boss configures and controls multiple (virtually unlimited) level sensing Smart:Nodes, including Smart:Nodes of different types, across (virtually unlimited) multiple vessels.

The Level:Boss dashboard displays graphical representation of state (e.g. On/Off, distance, Fill) of all level sensors in system. Using the Smart Logic techniques discussed above, Level:Boss allows user to configure sophisticated level controls by, for example, integrating multi-point level sensing with multiple pump and valve functions. Level:Boss may also include a calibration center with support for multi-point level control and template program modules for advanced sensor applications.

The Level:Boss may also include a user-selectable evaporation rates, and includes default and user-selectable values for start time delay and minimum fill time (to prevent fill valve cycling). Other features include user-selectable time or volume-based fill limits and user-configurable low water cutoff feature that provides option for user alert or pump deactivation. These limits may be overridden by service personnel with appropriate system permissions.

F. Temp:Boss

Temp:Boss allows users to configure control of popular fossil-fuel pool heaters, heat pumps/chillers, electric heaters, as well as heat exchangers and solar collectors. The Temp:Boss dashboard may display graphical representation of state (e.g. On/Off, setpoints, current temp) of all heating devices in system. Temp:Boss supports multi-heater installations and sequential activation and allows multiple set points (more than two) for multiple appliances across multiple vessels.

Temp:Boss also allows user to select a “learning mode” for heater programming Deploying proprietary PID functionality, Temp:Boss in Learning Mode analyzes historical heating data (including ambient air temperature, wind speed (if available)), learns how long it takes to reach set point, and automatically begins heat cycle so that set point is reached at user-set time.

Using SmartLogic (discussed above), Temp:Boss allows user to configure environmental limits for operation of appliances (e.g. “do not operate heater if outdoor temperature is less than 60° F.”). Temp:Boss may send a user alert (email or text message) when heater malfunctions during a heat program.

Temp:Boss also provides support for automatic solar collector control when interfaced with a valve controller and other necessary equipment.

G. Valve:Boss

Valve:Boss allows user to configure and control a virtually unlimited number of valves of different types. Valve:Boss may include a dashboard that displays graphical representation of state (e.g. On/Off, rotation angle) of all valves in system. User can set virtual rotation stops for flow throttling and the like. Valve:Boss supports multiple rotation stops on each valve.

Rotation stop settings can be locked and password-protected to prevent tampering. Valve:Boss also monitors and compares valve command state and actual rotation angle and sends ValveAlert message to user if valve becomes stuck.

H. Pump:Boss

Pump:Boss allows user to configure control of popular single-, dual-, and variable-speed pumps. The Pump:Boss dashboard may display graphical representation of state (e.g. On/Off, speed, flow etc.) of all pumps in system. Pump:Boss may allow high-resolution speed control (e.g. 10 rpm increments) of variable-speed pumps. Pump:Boss supports safety vacuum release system (SVRS) protection to single- and dual-speed pumps as well as variable speed pumps (VSPs). Selection of “Flow Priority Mode” for VSP control enables Pump:Boss to maintain constant flow rate instead of constant motor speed.

I. Light:Boss

Light:Boss allows the user to configure control of popular high voltage and low voltage underwater pool lighting and landscape lighting as well as providing for intuitive and easy creation and control of custom lighting circuits and groups. Upon device inclusion, Light:Boss automatically prompts the user to configure the lighting. Its configuration flexibility allows any combination of luminaires to be controlled individually or in groups, even across supply circuits (see Bridge:Uni:H above). Light:Boss further allows multiple group definitions, including overlapping definitions in which an individual luminaire may belong to more than one group. Light:Boss supports integration of DMX512-A controllers. The Light:Boss dashboard displays graphical representation of state of all luminaires in system (e.g. On/Off, dim level, color). Light:Boss may control incandescent, fiber optic, and LED luminaires using high-resolution 100-step dimming control and it supports advanced color management. Users may also select automatic shut-off during daylight hours.

J. Filter:Boss

Filter:Boss allows user to configure popular pool filters and may include a dashboard displaying graphical representation of dirt loading (and pressure reading) of all filters in system. Filter:Boss allows users to record clean filter readings (flow & pressure) with a button press or by manual entry. Filter:Boss may calculate default dirt alert limits based on clean readings. User may accept default or enter their own. In addition, users may choose actions that Filter:Boss takes when filter dirt level reaches limit, including dirt alerts or automatic backwash. For sand filters, Filter:Boss automates backwash via motor-actuated valves based on pressure differential and/or flow reduction. Backwash operation may be configured to terminate based on time, turbidity measurement of effluent, backwash water volume, or upon high water level reading in a backwash basin.

K. Cover:Boss

Cover:Boss provides the graphical status of automatic cover position and allows user to configure and customize autocover interlocks (e.g. “turn heater off when cover is open,” “turn waterfall off when cover is closed”).

L. Lawn:Boss

Lawn:Boss provides irrigation valve control and may include a dashboard displaying graphical representation of irrigation zones and state of all valves in system. Lawn:Boss allows user to configure virtually unlimited number of irrigation zones and valves and includes default programming allows program override based on rain history. Other features include the use of unlimited number of programs, custom text-based zone and valve names and fully-customizable duration intervals.

M. Cam:Boss

Cam:Boss allows user to configure multiple security and safety cameras. The Cam:Boss dashboard may displays all camera views in system and allows user to display one or more views on home/dashboard.

V. GreenMax

The GreenMax feature is an integrated hardware and software feature set within the VERV system that provides for monitoring and tracking of electricity, gas and water resource consumption.

A. Overall GreenMax Functions

The features of GreenMax may include:

1. Graphical data display for each resource that includes graphs, bar and pie charts.

2. Historical data for vessel(s) and individual devices (e.g. multiple pumps) displayed on screen or exported as MS Excel files (*.xls, *.xlsx) or CSV file.

3. Daily resource consumption data collection to user home screen/dashboard that allows users to create custom views or resource dashboards.

4. Users may create annual, monthly, weekly, and/or daily budgets for electricity, gas, and water consumption. When budget limit is reached, users may receive alert, and/or automatically shut off or lock out equipment.

5. For some GreenMax application, optional Smart:Nodes may be required. If the appropriate Smart:Nodes are installed, actual consumption data is provided. If optional Smart:Nodes are missing from network, estimates calculated by GreenMax are shown.

6. With user permission, GreenMax adds user consumption data to its global database and compares user data to other VERV users globally. This allows user efficiency to be graded (by rank or percentile) by user-selectable geographic region (e.g. country/state/county/postal code), by equipment model (e.g. users of same equipment), and the like. GreenMax may also provide user-selectable graphing and charting options.

7. GreenMax may calculate total system head for each circulation system and compare it to manufacturer published pump curve data in its database. User data is graphically displayed as curve overlay on manufacturer curve. With user permission, GreenMax adds total system head reading to its global database and compares it to other VERV users globally, and to manufacturer's system curve.

B. Electricity Features

GreenMax may be used to monitor and track electricity usage with one or more of the following features:

1. GreenMax national electrical utility database matches user vessel location (GPS module in Air:Hub) to corresponding electrical utility and rate structure. GreenMax prompts user to confirm utility match.

2. GreenMax creates default filter pump program based on the utility's off-peak times and rates.

3. GreenMax monitors utility rate structure for changes, and alerts user to any changes. “Smart Grid” features include user configurable responses to real time changes in utility energy demands and rates.

4. GreenMax uses data from (optional) Smart:Nodes to create graphical reports for one or more of the following for electricity monitoring and adjustment:

a. Electrical power consumed per unit time for each pump. User may select units of measurement (e.g. W/hr., kW/day, $/month).

b. Total power consumption of all or user-selected pumps per unit time.

c. Electrical cost per unit time for each pump (e.g. $/hr., $/day, $/week, $/month).

d. Total electrical cost of all or user-selected pumps per unit time.

e. Electrical power consumed per unit of flow (measures overall system efficiency) (e.g. W/gpm).

f. Electrical cost per unit of flow (e.g. $/gpm).

g. Power consumed per vessel turnover or filtration cycle (e.g. W/turnover, W/cycle).

h. Electrical cost per vessel turnover or filtration cycle ($/turnover, $/cycle).

i. Unit of flow vs. filter pressure curve.

j. Power consumed vs. filter pressure curve.

k. Electrical cost vs. filter pressure curve.

l. Power consumed per unit water temperature rise or fall (for heat pumps/chillers and electric resistance heaters).

m. Cost per unit water temperature rise or fall (for heat pumps/chillers and electric resistance heaters).

5. The user may create budget for any time interval (Annual/monthly/weekly/daily) based upon power consumed, energy cost, pump runtime, cumulative flow, turnovers and the like. The user may also pre-select action to take when budget limit is reached receive alert, shut off equipment, or lock out equipment.

C. Gas Features

1. GreenMax may use a national gas utility database that matches user vessel location (GPS module in Air:Hub) to corresponding gas utility and rate structure. GreenMax may prompt the user to confirm utility match. For LPG applications, the user may input unit cost information during web purchase or any time thereafter.

2. Using the Temp:Boss (see above), GreenMax may include user-configurable priority logic to automatically configure solar heaters, heat pumps/chillers, gas heaters and other heating appliances for maximum energy efficiency. In “Efficiency” mode, GreenMax may automatically select which heating equipment to operate based on resource cost and consumption, as well as environmental data provided by Smart:Nodes. In “Learning” mode, GreenMax saves energy by minimizing fuel burn time.

3. GreenMax uses data from (optional) Smart:Nodes to create graphical reports for one or more of the following for gas monitoring and adjustment:

a. Cost per degree vessel temperature rise (e.g. $/deg. F.).

b. Operating cost per unit time of heat appliance runtime (e.g. $/hour).

c. Vessel temperature rise per unit time heater runtime (e.g. deg. F./hour).

d. Gallons of fuel consumed per degree temperature rise (gas heaters only) (e.g. gal./deg. F.).

e. vessel temperature rise per hour vs. ambient air temperature.

f. vessel temperature rise per hour vs. wind speed.

4. The user may create budget for any time interval (Annual/monthly/weekly/daily) based upon power consumed, energy cost, pump runtime, cumulative flow, turnovers and the like. The user may also pre-select action to take when budget limit is reached receive alert, shut off equipment, or lock out equipment.

D. Water Features

1. GreenMax may use a national water company database that matches user vessel location (GPS module in Air:Hub) to corresponding water company and rate structure. GreenMax may prompt the user to confirm utility match. For users of private wells, there is a “Private Well” mode.

2. GreenMax may calculate water usage based on user-input flow rate and fill valve run time, or on actual flow rate through fill valve (suitable Smart:Node required).

3. GreenMax uses data from (optional) Smart:Nodes to create graphical reports for one or more of the following for water monitoring and adjustment:

a. Cost per unit time of fill valve runtime (e.g. $/hour).

b. Water consumption per unit time (e.g. gal./week).

c. cost per unit time (e.g. $/week).

d. water consumption comparison between user-selectable pump on/pump off (for preliminary leak investigations).

e. water consumption over time vs. vessel water temperature.

f. water consumption over time vs. ambient air temperature.

4. GreenMax uses vessel water consumption data to build local or regional database with baselines for evaporation rates. The GreenMax algorithm may account for seasonal variations and alert user when water use is higher than contemporary local average.

VI. VERV Configuration Wizard

Because VERV may involve complex decision-making protocols depending on the nature and extent of the system, VERV may include a configuration system using a simple menu-driven interface that guides users through non-technical system configuration process. The user configuration is continuously auto-saved for future reference by user, which allows configuration to be interrupted without data loss.

The control software may be pre-configured and pre-programmed to user specifications prior to shipping. And the wireless control network (for complete systems) may be pre-configured (including Smart:Node inclusion) and tested prior to shipping, creating a true “Plug-and-Play” user experience.

A wizard may also be used to collect vessel, node and equipment information to be used in control algorithms (as described above). The wizard may include a replicator option that allows user to quickly select configurations that mimic functionality offered by other popular control systems.

A VERV knowledge base may be established to ease the use of the system. The knowledge base may include a configuration FAQ section, an installation FAQ section, a supervised user forum, a system Wiki, a detailed, menu-driven troubleshooting guide, and a free phone support, unlocked with unique service “key” generated at end of troubleshooting guide.

VII. VERVFLEX Ownership Plan

To defray expenses for the VERV system, users may order from factory-direct sales to eliminate middlemen. The VERV system may use a simple price policy with a choice of low monthly lease payments (rental) or cash sales (ownership). There may also be simple rewards with volume discounts or credits for volume purchasers.

For additional ease for the user, all system components ship in a single box and include a simple set-up guides and how-to cards in the box that apply to user's specific equipment. A no-hassle, no-questions-asked return and exchange policy may also be offered.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. A system comprising:
a wireless mesh network having a wireless mesh network protocol;
a hub controller having a connection to the Internet and a connection to the wireless mesh network;
at least two aquatic components, wherein each of the at least two aquatic components is associated with a wireless control node that monitors the aquatic component associated with that wireless control node;
wherein the hub controller communicates wirelessly with a first wireless control node using the wireless mesh network protocol; and
wherein the first wireless control node communicates wirelessly with a second wireless control node using the wireless mesh network protocol.

2. The system as in claim 1, wherein at least one of the wireless control nodes further comprises radio signal shielding to minimize signal attenuation and distortion created by nearby metal objects and electromagnetic fields.

3. The system as in claim 1 further comprising a mobile device that wirelessly communicates with the hub controller to monitor and control at least two aquatic components in the wireless mesh network.

4. The system as in claim 1, wherein the hub controller and the at least two aquatic components are incorporated within at least one weatherized enclosure.

5. The system as in claim 1, wherein the power source for at least one wireless control node associated with an aquatic component is selected from the group consisting of solar power, energy harvesting, and battery power.

6. The system as in claim 5, further comprising a modular base configured to secure the at least one of the wireless control nodes to a pipeline.

7. The system as in claim 5 wherein the at least one of the wireless control nodes is a chemical sensor that is mounted within a pipeline.

8. The system as in claim 5, wherein the at least one of the wireless control nodes performs security functions for the wireless mesh network.

9. The system as in claim 5 wherein the at least one of the wireless control nodes is a full-range wireless variable-speed pump control.

10. The system as in claim 5 wherein the at least one of the wireless control nodes is a wireless valve operator for pool valves.

11. The system as in claim 5 wherein the at least one of the wireless control node controls a lighting device selected from the group consisting of landscape lighting and underwater lighting.

12. The system as in claim 1, wherein the power source for at least one wireless control node associated with an aquatic component is automatically detected by the at least one wireless control node and the power source is selected from the group consisting of solar power, energy harvesting, battery power, and line power.

13. The system as in claim 1 further comprising a modular relay platform;
wherein the power source for at least one aquatic component is line power and the wireless control node associated with that aquatic component comprises a modular relay that mates with a socket in the modular relay platform; and
wherein the modular relay platform is designed in a modular fashion to mate with the wireless control node associated with the aquatic component having a pre-defined form factor.

14. The system as in claim 1 further comprising at least one power switching relay module;
wherein the power source for at least one aquatic component is line power and where the power source for at least one aquatic component is low voltage power; and
wherein the at least one power switching relay module is designed to integrate with multiple voltages.

15. The system as in claim 1 further comprising a retrofit module platform;
wherein the power source for at least one aquatic component is line power and the wireless control node associated with that aquatic component comprises a modular relay that mates with a socket in the retrofit module platform; and
wherein the retrofit module platform is designed to mate with aquatic components having multiple form factors.

16. A system comprising:
a wireless mesh network having a wireless mesh network protocol;
a hub controller having a connection to the Internet and a connection to the wireless mesh network;
at least two aquatic components, wherein each of the at least two aquatic components is associated with a wireless control node that monitors the aquatic component associated with that wireless control node and communicates using the wireless mesh network protocol; and
a central manager to monitor and control the overall operation of the wireless mesh network via the wireless mesh network protocol.

17. The system as in claim 16 wherein the central manager further comprises at least one user profile, the at least one user profile comprising:
a permissions module for managing access parameters to the wireless mesh network;
a logging module for recording data generated by the wireless mesh network;
a learning module for monitoring and adapting the at least one user profile based on data generated by the wireless mesh network; and
a sharing module for optional sharing of user preference and system configuration data generated by the wireless mesh network.

18. The system as in claim 17 further comprising:
a wireless control node that communicates with the hub controller via the wireless mesh network protocol;
wherein the wireless control node is capable of performing functions when the wireless control node does not communicate with the hub controller.

19. The system as in claim 18, wherein the central manager further comprises an alerting module for notifying a user when a conflict within the mesh network occurs.

20. The system as in claim 19 wherein the central manager further comprises a programming module for combining data generated by the wireless mesh network with conditional statements to produce desired actions within the wireless mesh network.

21. A system comprising:
a wireless mesh network having a wireless mesh network protocol;
a hub controller having a connection to the Internet and a connection to the wireless mesh network;
at least two aquatic components, wherein each of the at least two aquatic components is associated with a wireless control node that monitors the aquatic component associated with that wireless control node;
a resources manager to monitor the electricity, gas and water consumption of the at least two aquatic components via the wireless mesh network protocol and to record network data related to the electricity, gas and water consumption in a network database.

22. The system as in claim 21 wherein the resources manager further comprises a utility module for interfacing with an outside utility and outside utility data.

23. The system as in claim 21 wherein the resources manager further comprises a manufacturer module for comparing the network data in the network database with performance data related to the at least two aquatic components as provided by the manufacturers of the at least two aquatic systems.

24. The system as in claim 21 wherein the resources manager further comprises a budgeting module for setting consumption thresholds for electricity, gas and water consumption within the wireless mesh network and establishing a responding mechanism when a threshold is exceeded.

25. The system as in claim 21 wherein the resources manager further comprises a learning module for monitoring electricity, gas and water consumption within the wireless mesh network and adjusting the parameters of the at least two wireless control nodes so as to increase the efficiency of electricity, gas and water consumption of the at least two aquatic components within the wireless mesh network.

26. An apparatus comprising:
a pool cover;
a drive system for extending and retracting the pool cover over an aquatic vessel;
at least two wireless control nodes that monitor and control the pool cover and communicates within a wireless mesh network via a wireless mesh network protocol;
wherein the pool cover comprises:
a cover leading edge having an edge monitor for determining leading edge location and orientation; and
a low-stretch cover fabric connected to the cover leading edge.

27. The apparatus as in claim 26 further comprising a cover drum and wherein the drive motor is mounted concentrically inside the cover drum so that the pool cover is rolled onto the cover drum when retracted.

28. The apparatus as in claim 26 further comprising a cover drum and wherein the drive motor is mounted eccentrically to the cover drum so that the pool cover is rolled onto the cover drum when retracted.

29. The apparatus as in claim 26 further comprising a first track, a second track, a first track wireless motor and a second track wireless motor;
wherein the pool cover comprises a first lateral cover edge and a second lateral cover edge; and
wherein the first lateral edge engages with the first track while the pool cover is being driven and retracted by the first track wireless motor; and
wherein the second lateral edge engages with the second track while the pool cover is being driven and retracted by the second track wireless motor.

30. The apparatus as in claim 26 further comprising a first track, a second track, a first track magnetic drive and a second track magnetic drive;
wherein the pool cover comprises a first lateral cover edge and a second lateral cover edge; and
wherein the first lateral edge engages with the first track while the pool cover is being driven and retracted by the first track magnetic drive; and
wherein the second lateral edge engages with the second track while the pool cover is being driven and retracted by the second track magnetic drive.
